(19) United States
(12) Patent Application Publication
(10) Pub. No.: US 2019/0222878 A1
(43) Pub. Date: Jul. 18, 2019

(54) SYSTEM AND METHOD FOR MANAGING IN-FIELD DEPLOYMENT OF MULTIPLE CONDITIONAL ACCESS AND WATERMARKING SYSTEMS

(71) Applicant: INSIDE SECURE, Meyreuil (FR)

(72) Inventors: Ronald P. Cocchi, Seal Beach, CA (US); Jacob T. Carson, Long Beach, CA (US); Michael A. Gorman, Cypress, CA (US); Dennis R. Flaharty, Shingle Springs, CA (US); Gregory J. Gagnon, Redondo Beach, CA (US); Matthew A. Skubiszewski, Hermosa Beach, CA (US)

(73) Assignee: INSIDE SECURE, Meyreuil (FR)

(21) Appl. No.: 16/363,958

(22) Filed: Mar. 25, 2019

Related U.S. Application Data
(63) Continuation-in-part of application No. 15/937,772, filed on Mar. 27, 2018, now Pat. No. 10,277,935.
Application No. 15/937,772 is a continuation of application No. 15/167,319, filed on May 27, 2016, now Pat. No. 9,942,586.
Application No. 15/167,319 is a continuation of application No. 13/981,289, filed on Jul. 23, 2013, now Pat. No. 9,355,426.
Application No. 13/981,289 is a continuation-in-part of application No. 15/791,260, filed on Oct. 23, 2017.
Application No. 15/791,260 is a continuation-in-part of application No. 14/382,539, filed on Sep. 2, 2014, now Pat. No. 9,800,405.
(60) Provisional application No. 61/436,485, filed on Jan. 26, 2011.
(60) Provisional application No. 62/446,196, filed on Jan. 13, 2017.
(60) Provisional application No. 61/606,260, filed on Mar. 2, 2012.

(51) Int. Cl. H04N 21/254; H04N 21/845; H04N 21/438; H04N 21/8358; H04N 21/426; H04N 21/433; H04N 21/4627; G06T 1/00; H04N 5/913

(52) U.S. Cl. CPC H04N 21/2541; H04N 21/845; H04N 21/438; H04N 21/8358; H04N 9/8063; H04N 21/4334; H04N 21/4627; G06T 1/0021; H04N 5/913; H04N 21/42684

(57) ABSTRACT

A method and apparatus for controlling a group of the client devices to switch at least one client device of the group of client devices from a first conditional access system to a second conditional access system or to update conditional access parameters such as keys or watermarking parameters is disclosed.

### CROSS-REFERENCE TO RELATED APPLICATIONS

This application is a Continuation-in-Part of U.S. patent application Ser. No. 15/937,772, entitled “METHOD AND APPARATUS FOR HARDWARE-ENFORCED, ALWAYS-ON INSERTION OF A WATERMARK IN A VIDEO PROCESSING PATH,” by Dennis R. Flaharty et al., filed Mar. 27, 2018, which application is a continuation of U.S. patent application Ser. No. 15/167,319, entitled “METHOD AND APPARATUS FOR HARDWARE-ENFORCED, ALWAYS-ON INSERTION OF A WATERMARK IN A VIDEO PROCESSING PATH,” by Dennis R. Flaharty et al., filed May 27, 2016, now issued as U.S. Pat. No. 9,942,586, which application is a continuation of National Stage application Ser. No. 13/981,289, entitled “HARDWARE-ENFORCED, ALWAYS-ON INSERTION OF A WATERMARK IN A VIDEO PROCESSING PATH,” by Dennis R. Flaharty et al., filed Jul. 23, 2013, now issued as U.S. Pat. No. 9,355,426, which application is a National Stage of International Application No. PCT/US2012/022791, entitled “HARDWARE-ENFORCED, ALWAYS-ON INSERTION OF A WATERMARK IN A VIDEO PROCESSING PATH,” by Dennis R. Flaharty et al., filed Jan. 26, 2012, which application claims benefit of U.S. Provisional Patent Application No. 61/436,485, entitled “ALWAYS ON, HARDWARE ENFORCED WATERMARK,” by Dennis R. Flaharty et al., filed Jan. 26, 2011.

This application is also a Continuation-in-Part of U.S. patent application Ser. No. 15/791,260, entitled “SIGNALING METHOD FOR CAS SWITCHING AND KEY DERIVATION,” by Jacob T. Carson, Michael A. Gorman, and Ronald P. Cocchi, filed Oct. 23, 2017, which application:
claims benefit of U.S. Provisional Patent Application Ser. No. 62/446,196, entitled “SIGNALING METHOD FOR CAS SWITCHING AND KEY DERIVATION,” by Jacob T. Carson, Michael A. Gorman, and Ronald P. Cocchi, filed Jan. 13, 2017;
is also a continuation-in-part of U.S. patent application Ser. No. 14/382,539, entitled “BLACKBOX SECURITY PROVIDER PROGRAMMING SYSTEM PERMITTING MULTIPLE CUSTOMER USE AND IN FIELD CONDITIONAL ACCESS SWITCHING,” by Ronald P. Cocchi et al., filed Sep. 2, 2014, which application is a National Stage Entry of international patent application PCT/US13/28761, entitled “BLACKBOX SECURITY PROVIDER PROGRAMMING SYSTEM PERMITTING MULTIPLE CUSTOMER USE AND IN FIELD CONDITIONAL ACCESS SWITCHING,” by Ronald P. Cocchi et al., filed Mar. 1, 2013, which application claims benefit of U.S. Provisional Patent Application Ser. No. 61/606,260, entitled “BLACKBOX SECURITY PROVIDER PROGRAMMING SYSTEM PERMITTING MULTIPLE CUSTOMER USE AND FIELD CONDITIONAL ACCESS SWITCHING,” by Ronald P. Cocchi et al., filed Mar. 2, 2012.

All of which applications are hereby incorporated by reference herein.

### BACKGROUND OF THE INVENTION

### 1. Field of the Invention

The present invention relates to systems and methods for securely providing data for use by a hardware device of a receiver for conditional access including, for example, watermarking information.

### 2. Description of the Related Art

The provision of information such as media programs to remote consumers is well known in the art. Such provision may be accomplished via terrestrial or satellite broadcast, cable, closed circuit, or Internet transmission to consumer electronics (CE) devices at the consumer's home or office.

A common problem associated with such transmission is assuring that the reception of such information is limited to authorized end-users. This problem can be solved via the use of encryption and decryption operations performed by devices with appropriate security functionality. For example, it is well known to encrypt media programs before transmission to CE devices with electronics and processing that permits the encrypted media programs to be decrypted and presented to only authorized users.

To implement this functionality, the CE products typically include keys, software, and other data. Since such data is of value to unauthorized users as well, CE companies need a way to protect this valuable information.

Typically, this has required the production of CE devices with special integrated circuits (or chips) with security features enabled and information needed to perform the security functions loaded into chip memory. Such chips can include System on Chips (SOC), which comprise the primary Central Processing Unit (CPU) of the CE device (which may also include secondary processors, security processors, custom Application Specific Integrated Circuits (ASICSs), etc.) or other chip devices that perform the processing of commands within a CE device. Conditional Access providers provide content protection schemes to secure broadcast content is paid for when viewed by subscribers. Problems arise when the content protect schemes are either compromised or implemented in a man which security holes or flaws can be exploited by attacker. The cost to design, manufacture and distribute these CE devices is extremely expensive. Significant savings can be achieved if a service provider or broadcaster can re-purpose existing CE devices by replacing the conditional access (CA) system used with CE devices that are in the field (distributed to or in use by customers). As an alternative to switching CA systems, the CE device can be provisioned to support separate and cryptographically isolate CA systems during manufacture. This permits the security provided by another CA vendor to be used in the event the security provided by another one of the CA vendors and co-existing on the chip, is compromised.

In addition to providing conditional access, movie studios and other owners of the intellectual property in media programs have been attempting, without success, to mandate the use of watermarking to aid forensic analysis of pirated materials.

Digital watermarking is one technique that can help protect such intellectual property. Digital watermarking is a process by which information in the signal itself can be used to verify the authenticity or identity of the owners or to trace the source of a media program. Watermarking may include visible or invisible watermarking. With visible watermarking, the information discernable in the media program without special equipment. An example of a digital watermark is a logo or bug that might be placed in the corner of one or more frames of the media program. With invisible watermarking, the information is added to the media program in such a way that it cannot be easily perceived without special equipment.

Watermarking can prevent unauthorized copying or distribution of media programs in two ways. First, a watermark can be inserted into the media program, and retrieved and examined before any copy of the media program is permitted. In this example, if the watermark cannot be retrieved, or if the retrieved watermark indicates that copying is not permitted, copying is disabled. Second, a watermark may also allow the owner to perform source tracing to determine where the unauthorized copy was procured. In this system, a watermark is embedded into the media program at each point of distribution or copying. If an unauthorized copy of the work is later found, the watermark(s) may be retrieved, and the chain of distribution can be identified back to the source of the unauthorized copy.

To date, several companies have marketed watermarking technologies but without much success in the market due to several significant technical and economic reasons such as design complexity and high operational overhead. For these reasons, the broadcasters of such media programs have not adopted watermarking technologies even though those who own the intellectual property are pushing strongly for adoption of a solution. A simple, low cost, and near zero broadcast infrastructure impact design can address this problem.

The current providers of watermarking technology either have (1) large clients disposed at the headend (transmitting facility) and lighter set top box (STB) or receiver software kernels at the subscriber facility or (2) lighter headend clients with larger and more sophisticated STB kernel clients. In either case there is a high level of complexity and cost to gather identifiable forensic data. Some of these complexities include finding the appropriate space in the video to insert the data while keeping the watermark as invisible as possible so as to avoid disrupting the viewing experience, redesigning the broadcasters headend to integrate a set of watermarking servers and adding a large software kernel to the STB code and re-qualify the STB code to verify correct operation of new and old functionality. In some current watermarking designs after the broadcast and STB systems are re-designed there are sophisticated retrieval process and procedures needed to be developed to capture the data from pirated materials in order to recover the forensic data.

All of these systems come at a high cost. Some watermarking companies require payment of substantial fees such as Non-Recurring Engineering (NRE) effort fees to obtain or use the required headend client, STB kernel client and forensic retrieval clients. They also require fees for keying materials or per usage licenses. All of which are burdensome to the broadcaster/customer.

Furthermore, watermarking by lighter STB or receiver software kernels often requires the ability to remotely update watermarking parameters so that different watermarks are applied to different content, or if watermarking operations or parameters have been compromised.

What is needed is a system and method for providing a security infrastructure that permits the programming of unique security functions CA and watermarking systems. The present invention satisfies that need.

### SUMMARY OF THE INVENTION

To address the requirements described above, the present invention discloses a method of watermark data to a media program in a receiver disposed at a subscriber station, the receiver having a secure data processor communicatively coupled to a secure memory. In one embodiment, the method comprises receiving the media program in the receiver, generating, at least in part with a data processor executing processor instructions, a watermark, wherein the watermark is generated at least in part according to a data processor-unique identifier (PID), processing the received media program to reproduce the media program, and inserting portions of the generated watermark in the reproduced media program as determined at least in part according to the data processor-unique identifier to produce a watermarked media program provided for display. Inserting portions of the generated watermark in the reproduced media program as determined at least in part according to the data processor-unique identifier to produce a watermarked media program provided for display comprises inserting a first portion of the portions of the generated watermark in a first portion of a first frame of the reproduced media program and inserting a further portion of the portions of the generated watermark in a further portion of a further frame of the media program, wherein at least one of the further frames of the media program and a segment of the further portion of the generated watermark within the further frame of the reproduced media program is selected at least in part according to the data processor-unique identifier.

The receiver PIDs can be transmitted or updated by receiving an encrypted customer global key E[CGK], receiving encrypted data ECGK[D], wherein the data (D) is encrypted according to the customer global key (CGK), decrypting the encrypted customer global key E[CGK] to reproduce the customer global key, decrypting the encrypted data ECGK[D] with the reproduced customer global key to reproduce the data (D), and securely storing the reproduced data (D) in the secure memory of the secure data processor. The data (D) may include the secure data processor-unique identifier (PID), or CE devices software, including Whitebox software.

Hence, disclosed herein is a system and method that a service provider or broadcaster to utilize high security chip device features to enable in-field switching of CA vendors and/or co-existence of CA vendors for fielded CE Devices, and also PIDs and other parameters used to generate watermarks in fielded devices.

### BRIEF DESCRIPTION OF THE DRAWINGS

Referring now to the drawings in which like reference numbers represent corresponding parts throughout:

FIG. 1A is a diagram of selected architectural entities described in this disclosure;

FIG. 1B is a diagram of an exemplary chip;

FIG. 2 illustrates the customer product differentiator field and signed hash block used to verify third party customer input data for fielded SOCs;

FIG. 3 illustrates the Boot ROM signature check over the code section enabling insertion of a CA vendor Public RSA key in a fielded SOC;

FIG. 4A illustrates use of a Secret Value stored in hardware to protect a given CA vendor customer's common block of data or key;

FIG. 4B illustrates use of a Secret Value and Product Provisioning Key both stored in hardware to protect a CA vendor's common block of data or key;

FIG. 5A is a diagram presenting illustrative method steps that can be used to enable encryption of sensitive code or data and provide it to an independent CA vendors or untrusted consumer electronics (CE) device manufacturer for provisioning;

FIG. 5B is a diagram illustrating use of a product provisioning key and secret value stored in hardware to protect a CA vendors' common block of data or key enabling in-field insertion of a secret value post SOC manufacturing;

FIG. 6 is a diagram of one embodiment of the product identifier (PID) described above;

FIG. 7 illustrates the boot process, image signing and RSA public key authentication for over the air updates;

FIG. 8A is a diagram illustrating exemplary method steps that can be used to deliver the unlocking data;

FIG. 8B illustrates a more specific example of the calculation and distribution of customer validation data by the CE source 108 after the chip 114 is manufactured;

FIG. 9 is a diagram illustrating exemplary method steps for controlling a group of client devices to switch from a first CAS to a second CAS via a plurality of client device signaling messages;

FIG. 10 is a diagram illustrating exemplary operations performed by the client devices in receiving and handling the first client device message and the second client device message;

FIGS. 11-12 illustrate the operations presented in FIGS. 9-10 in greater detail; and

FIG. 13 is a diagram illustrating an exemplary media program distribution system;

FIG. 14 is a diagram illustrating an exemplary embodiment of a receiver;

FIG. 15 is a diagram presenting an exemplary for inserting and recovering the watermark;

FIGS. 16 and 17 are a diagram illustrating one embodiment of how the watermark may be generated

FIG. 18 is a diagram illustrating exemplary method steps that can be used to insert the watermark into the frame(s);

FIGS. 19A-19C are diagrams showing a particular example of the generation of a watermark and its insertion into multiple frames of the media program;

FIG. 20 is a diagram illustrating exemplary method steps that can be used to recover the watermark;

FIGS. 21A-21C are diagrams illustrating a comparison with a blackbox implementation of a decryptor and fixed and dynamic key Whitebox embodiments of the decryptor;

FIG. 22 is a diagram illustrating an exemplary Whitebox implementation;

FIG. 23 is a diagram illustrating a CE device having multiple Whitebox implementations; and

FIG. 24 is a diagram illustrating an exemplary computer system that could be used to implement elements of the present invention.

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

This disclosure describes a system and method that allows third parties to provide set top boxes with advanced security features that (1) allow the signing of a customer's public key, (2) allow programming of chips with secret keys at chip manufacturing facility and (3) provide service providers a method to independently allocate those secret keys to security vendors when the CE device is in the field and (4) securely provide watermarking parameters such as identifiers to fielded CE devices.

### Architectural Entities

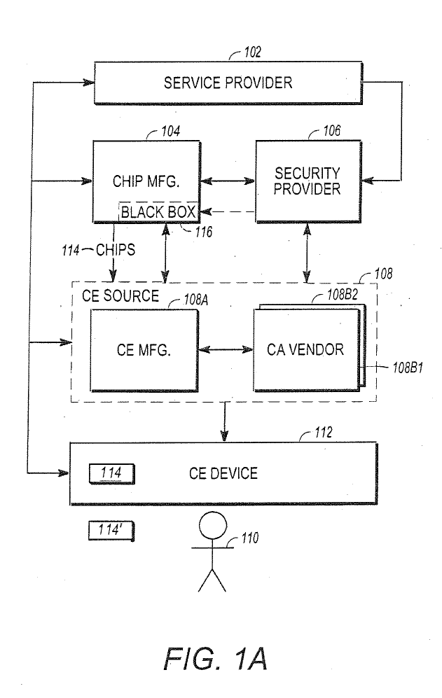

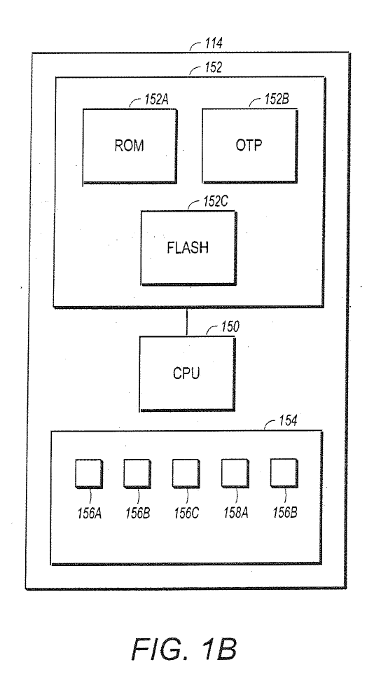

FIG. 1A is a diagram of selected architectural entities described in this disclosure. They include a service provider 102, a chip manufacturer 104, a security provider 106, a third-party vendor(s) 108 and subscriber(s) 110. The service provider 102 transmits media programs and information to consumer electronics (CE) device(s) 112 that are deployed to subscribers 110. The CE device 112 presents the media programs to the subscribers 110. The CE device 112 can include devices such as set-top boxes (STBs) integrated receiver/decoders (IRDs) portable CE devices such as cellphones or personal data assistants (PDAs), laptop computers, tablet computers, and desktop computers. Any device with the required processing and memory capacity having the proper programming or hardware can be used as a CE device. An exemplary IRD is disclosed in U.S. Pat. No. 6,701,528, which is hereby incorporated by reference herein.

To assure that only authorized subscribers 110 receive the media programs and information, the CE devices 112 perform security functions that are implemented at least in part using hardware processing/memory devices 114 (hereinafter alternatively referred to as chips) that are produced by chip manufacturer 104. For example, the transport module of the IRD disclosed in U.S. Pat. No. 6,701,528, is typically implemented by a chip.

FIG. 1B is a diagram of an exemplary chip 114. The chip 114 comprises memory 152 communicatively coupled to a processor or CPU 150. The memory 152 stores instructions and/or data such as keys that are used to implement the conditional access functionality of the CE device 112. The memory 152 may include read only memory (ROM) 152A, one-time-programmable memory (OTP) 152B, and flash memory 152C. The chip 114 may also comprise a configuration portion 154, which may include a series of fuses 156A-156C and/or flags 158A-156B. The flags 158 may also be reflected by values in the memory 152. The fuses 156 are irreversibly activated by the chip manufacturer 104 to implement particular chip 114 functionality. For example, activation of fuse 156A may activate a triple data encryption standard (DES) functional capability of the chip 114, while fuse 156B may activate an RSA encryption functionality.

The CE devices 112 are manufactured by a CE source 108. In one embodiment, the CE source 108 is defined to include a particular CE manufacturer 108A that is responsible for the manufacture of a CE device 112 having hardware and software capable of implementing the CA functions allocated to the CE device 112 by a particular CA vendor 108B, which provides the instructions and data (for example, software and keys) that are used by the CE device 112 hardware to implement the CA functions required for the CA system used by the service provider 102. A particular CE source 108 is identified by a particular CE manufacturer's 108A product used with a particular CA system from CA vendor 108B used with the CE device 112. For purposes of the discussion below, when the same CE device 112 is used with the instructions and data (or smart card implementing some or all of the instructions and data) from two different CA vendors 108B, this represents two distinct CA sources 108

In one embodiment, the CE device 112 hardware is capable of performing the CA functions allocated to the CE device 112 for multiple CA vendors 108B at the same time. For example, a first CA vendor 108B1 (CA vendor 1) may define a CA system that allocates a first set of CA functions to the CE device 112, and a second CA vendor 108B2 (CA vendor 2) may define a second CA system that allocates a second set of CA functions at least partially different than the first set of functions to the CE device 112. The CE device 112 may support both CA systems by storing instructions and data that allow the CE device hardware to perform the CA functions allocated to the CE device 112 in both the first CA system and the second CA system. Thus, using the CA functionality provided by both the first CA vendor 108B1 and the second CA vendor 108B2, the fielded CE device 112 may be capable of performing the CA functions needed to receive and decrypt media programs and data transmitted by two different service providers 102 (for example, DIRECTV AND ECHOSTAR).

The CE device 112 hardware may also support the replacement or substitution of one set of allocated CA functions for another set of allocated functions. For example, rather than support both the first set and the second set of allocated CA functions, the CE device 112 hardware may be configured such that a first set of allocated CA functions is automatically disabled when the second set of allocated CA functions are enabled. This would allow, for example, a receiver initially configured to receive media programs from a first service provider 102 to be de-configured from receiving such programs, and to instead receive media programs from a second service provider 102. Or, the first service provider 102 could desire a change its content protection services from its initial CA vendor 108B1 to those provided by a second CA vendor 108B2.

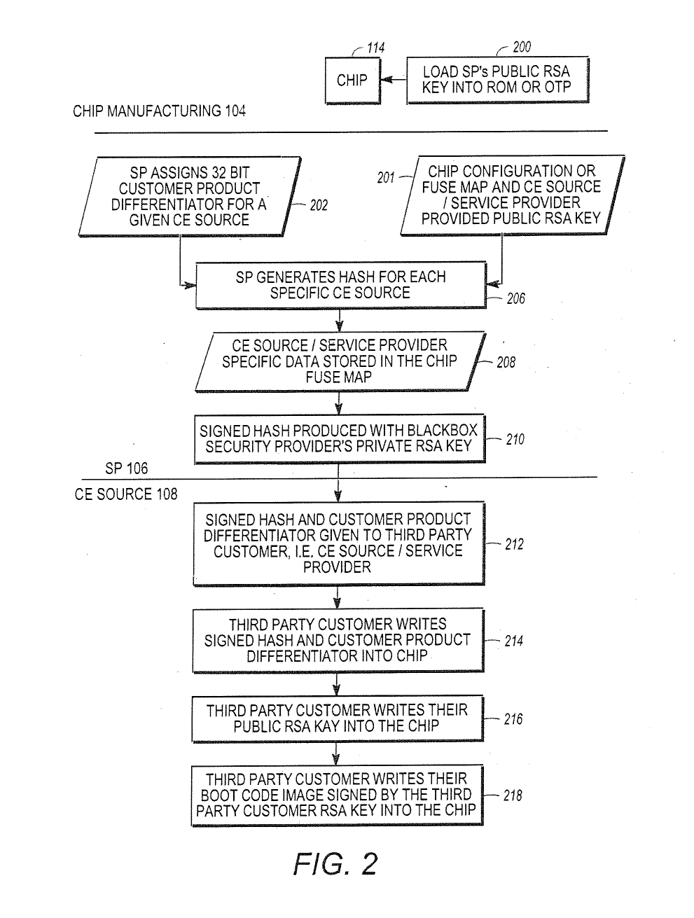

In another embodiment, the CE device source 108 may also include one or more CA vendors 108B that are architectural entities separate from the CE manufacturer 108A. For example, the CE device 112 may employ a smart card 114′ (for example, as shown by the access card of FIG. 2 of U.S. Pat. No. 6,701,528) or other removable security device having security functions defined by the CA vendor 108B. The CA vendor 108B may manufacture and provide this security device 114′ to the CE manufacturer 108A for ultimate provision to the subscriber(s) 110 with the CE device 112.

The CE source 108 may accept chips 114 from the chip manufacturer 104 and install them into the CE device 112. As described below, the present invention allows the chips 114 to be a standard design, yet uniquely and remotely programmable so as to be useful for CE devices 112 from different CE manufacturers 108A, and that can perform the allocated CA functionality for multiple CA systems enabled by different CA vendors 108B and used by different service providers 102.

In one embodiment, the chips 114 are programmed via use of a black box 116 provided by a third-party security provider 106. The black box 116, as the name implies, is a device that performs a transformation of data such as code or keys, without revealing how the transformation is performed or disclosing the data. The use of the black box 116 in this instance, allows the security provider 106 to program instructions and/or data into the chip 114 at the chip manufacturer's facility and under the control of the chip manufacturer 104 without exposing that information and/or data itself to the chip manufacturer 104.

Data from the security provider 106 or the service provider 102 may also be programmed into the chip 114 at the CE source 108 or the subscriber 110 location using the techniques described below.

### Customer Product Differentiator Field

A customer product differentiator, somewhat analogous to a customer number, is used by the security provider 106 and/or the chip manufacturer 104 to identify a customer specific configuration of a specific chip 114 for the functions to be performed by the CE Device 112 from a particular CE Source 108. The customer product differentiator (CPD 202) may be assigned to a particular CE Source 108 or service provider 102, for example, PANASONIC, DIRECTV or ECHOSTAR. Further, a single service provider 102 or CE source 108 may have different CPDs for products that are used in different markets if those products require chips that implement different security functions. In one embodiment, the customer product differentiator comprises a bit customer product differentiator (CPD 202) represented by a 32-bit field.

FIG. 2 is a diagram illustrating the use of the CPD 202. A customer product differentiator or CPD field 202 is generated and used with a signed hash block 210 to verify CE source 108 input data before that data is used in fielded chips 114 (i.e. deployed in fielded CE devices 112 installed at subscriber 110 locations). The security provider 106 uses the CPD 202 field as part of an input to fix chip 114 security data received from the CE source 108 (such as a specific flash-based CE source 108 public RSA key) to a given value. Optionally to further increase security, the address location for a flash-based third-party public RSA key and/or the CPD 202 can also be used fix input data for a given CE source 108 and incorporated into the signed hash block 210.

This process can be implemented as follows. In block 200, the public RSA key of the security provider 106 is stored in ROM 152A at the mask level or OTP 152B using the black box 116. Customer-specific data 208 is generated by combining the CPD 202 with a public key 201 of the CE source 108 and optional chip configuration information, as shown in block 206.

Chip configuration information may vary according to the CA functions to be implemented by the chip 114 in the CE device 112. For example, a particular chip 114 may have the ability to implement a plurality of encryption/decryption schemes, depending on the setting of internal flags of the activation of internal fuses 156. The chip 114 configuration information may describe the enabled functionality of the chip 114 by indicating, for example, which flags are set and/or which fuses 156 are activated.

Typically, the above combination operation 206 is performed by the security provider 106. In one embodiment, the CPD field 202 is assigned by the security provider 106 and the combining operation of block 206 is a hash operation. The result is CE source 108 data 208 that is unique and specific to that CE source 108 and customer product. This data may be stored in a map which controls the activation of fuses 156.

In block 210, the customer-specific data 208 generated above is signed with a private key of the security provider 106 Kpr_{SP}. In blocks 212 and 214, this signed combination and the customer product differentiator or CPD 202 is provided to the CE source 108. The CE source 108 writes the signed customer data 208 and the customer product differentiator or CPD 202 to a memory 152 of the chip 114. The customer data 208 signed with the security provider's 106 private RSA key is also securely stored at the CE source 108 site for use in the generation of future customer operations.

In blocks 216-218, the CE source 108 writes their CE source public key (Kpu_{CE}) into a memory 152 of the chip 114 and also writes an image of the CE device 112 boot code signed by the private key of the CE source 108 into memory 152c of the chip 114. Boot code comprises coded instructions that are verified and executed automatically when a CE device 112 is powered up.

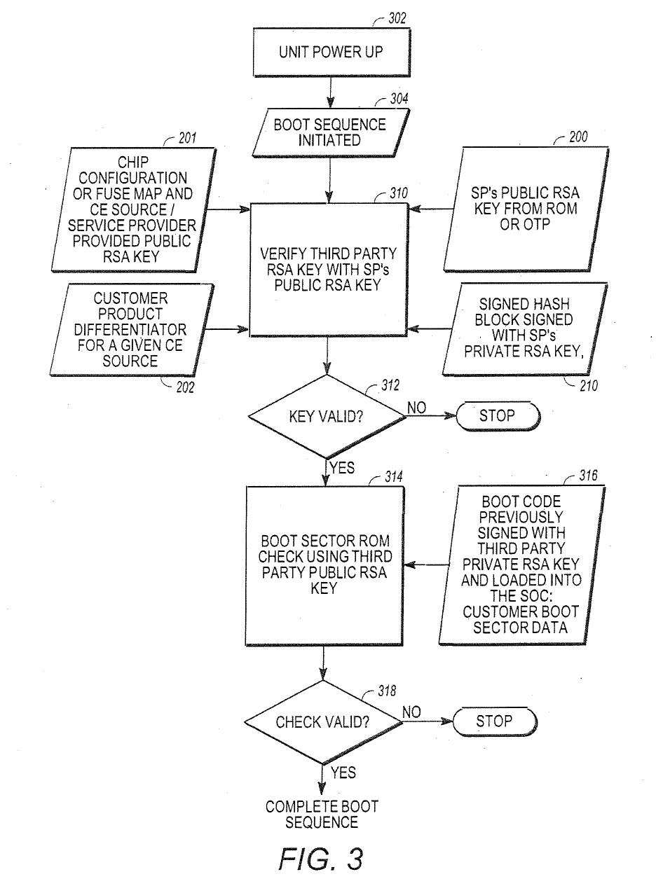

The chip 114 is thereafter installed into the customer device 112 by the CE manufacturer 108A, and provided to the subscriber 110 for use. When the customer device 112 and chip 114 are powered up, a boot code is verified as shown in block 318, then executed by the chip 114, as further described with reference to FIG. 3.

Continuing with the operations illustrated in FIG. 2, the security provider 106 generates the signed hash block over the customer-specific data using the chip 114 configuration (provided in block 201), the CE source's public RSA key, and the CPD field 202, as shown in block 210. The CE source 108 can store the signed hash CPD field 202 in one-time programmable (OTP) memory 152B location of the chip 114 as shown in block 214, however, the CPD 202 could reside in flash memory for example in cases where there is not enough OTP or the chip 114 does not support OTP. If the CE source 108 or other entity were to alter the CPD field 202 or the CE source's public RSA key, then the RSA signature validation described below and illustrated in blocks 310 and 312 using the security provider's 106 signed hash block 308 would fail and the chip 114 will not completely execute the boot code instructions, and will chip 114 and CE device 112 will be otherwise unusable. This is further described below.

The security provider's public RSA key is embedded in Read Only Memory (ROM) 152A or One Time Programmable memory (OTP) 152B within the chip 114 as described below with reference to FIG. 3. This serves as the hardware root of trust in the chip 114.

### Boot ROM Signature Check

U.S. Patent Publication 2007/0180464, entitled “Method and System for Restricting use of Data in a Circuit,” (hereby incorporated by reference herein) discloses a method for checking the signature of boot code stored in ROM. These techniques can be extended to support code protection as discussed herein.

The security provider 106 supplies a 2048-bit RSA public key that is stored in a ROM 152A of the chip 114 or an OTP bank 152B within the chip 114, as shown in block 200.

An Elliptical Curve Cryptography (ECC) key could also be used to perform asymmetric cryptographic operations in a similar manner to which is described below using RSA. Public key storage in a ROM 152A of the chip 114 is preferred and is the most secure location because it cannot be changed in the field, however, storage as data in the OTP 152B still provides a hardware root of trust. This can be implemented by programming the chip 114 using the black box 116 provided by the security provider 106 during chip 114 manufacturing.

The chip 114 may also include boot code that is used upon power up to boot or start the chip 114. In one embodiment, this boot code is signed by the CE source's private key, before storage in the chip 114 so as to permit later validation before further processing as described below.

FIG. 3 is a diagram presenting an exemplary embodiment of how the boot code image can be verified before it is executed by the chip 114. When the CE device 112 is powered up, a boot sequence is initiated by the chip 114, as shown in blocks 302 and 304. Next, the public key of the second entity (in this case, the CE source 108) is verified.

Recall that the signed hash (which was generated with the CE source's public RSA key and the CPD) was stored in block 214 and the CE Source's public key was stored in the chip 114 in block 216. That hash can be recomputed in the chip 114 using the CPD 202 that was stored in the chip 114 in block 214, the CE Source public RSA key stored in the chip in block 216, and the chip configuration data. Further, the signature over the hash, i.e. the signed hash, stored in block 214 can be verified using the security provider's 106 public key which is retrieved from the ROM 152A or OTP 152B of the chip 114. The hash will only be equivalent to the recomputed hash if the CE source's public RSA key written in block 216 is equivalent to the CE source's public RSA key used to generate the hash in block 206 are equivalent.

If the comparison indicates that the CE source's public key is not valid, processing stops and the chip 114 will fail to exit the reset mode. If the comparison indicates that the CE source's public key is valid, processing is passed to block 314 where the boot sequence is verified using the verified CE source's public key.

If the boot sequence is verified, the boot code image is verified as shown in blocks 314-318 and the boot code is executed. If the boot sequence is not verified, chip 114 will again fail to exit the reset mode and will be non-operational.

In the above operations, a hardware security co-processor built into the chip 114 can read the CE source's public RSA key (which was stored in block 216) from memory such as a flash location in the chip 114 and use it to verify the stored signature for the customer application code that has been calculated over the entire section of customer application code to be downloaded for execution. The chip 114 memory location from which the security provider's 106 public RSA key is read may be fuse 156 locked to a specific ROM 152A or OTP 152B key by the chip manufacturer 104, that is, at electronic wafer sort or when sensitive immutable data is stored in the chip 114 by the black box 116 provided to the chip manufacturer 104 by the security provider 106. In one embodiment, once the location of the security provider's 106 public RSA key 200 has been selected, it cannot be changed in the field. This security provider 106 public RSA key is used as the chip's hardware root of trust in code signing, thereby, enabling use of at CE source 108 or CA vendor 108B public RSA key.

The main processor or central processing unit (CPU) 150 of the chip 114 incorporated into the CE device 112 may be held in a reset mode until the boot code check of blocks 314-318 is completed, thereby, eliminating the possibility of executing unknown user or malicious boot code.

Typically, the chip 114 must support the ability to extend the public ROM/OTP keys held by the security provider 106 to CE source 108-defined RSA keys by checking a signed hash stored in the chip 114. This enables a first entity, such as the security provider 106, to sign the public RSA keys of the second entity (such as the CE source 108-defined public RSA keys) and allows validation of the CE source's 108 public RSA key based on the security of the root of trust in the security provider's public RSA key stored in ROM/OTP 152A/152B. Preferably, this hardware-based validation process occurs in a secure manner that is not modifiable or accessible by other elements in the CE device 112 such as a general-purpose processor 904A or general-purpose processor 904B. This process is typically controlled by a hardware state machine or performed on a separate embedded security co-processor executing from a private secure memory location.

The signed hash 210 used to validate the CE source's public RSA key incorporate the CPD 202 field assigned by the first entity (the security provider 106) to properly bind the CE Source's public RSA key to a specific party, that is, the CE Source 108 to which the CPD 202 was assigned. Incorporating additional information such as the address of the memory 152 location of where the CPD 202 value and/or CE source's public RSA are stored further limits potential attacks by fixing values to particular areas in a map of the memory 152 of the chip 114.

Having either the CPD field 202 or CPD address field incorporated into the signed hash 210 also enables the CE source 108 to assign an alternate CPD field 202 and/or CPD address, either of which enables switching from a first CA vendor 108B1 to a second CA vendor 108B2 as discussed below.

Incorporating either the CPD field 202 or CPD address field into the signed hash enables the CE Source 108 to revoke a previously assigned CE source 108 public RSA key by changing the value of the CPD 202 itself, assigning a new CE source public RSA key for a new CE source 108 and sending a new software image as is also discussed below. The previously signed CE source public RSA key will no longer be successfully validated by the security provider's signed hash 210 since the signed hash incorporates the old CPD value 202, which will no longer pass the verification process of blocks 310 and 312 of FIG. 3 since the CPD value 202 has changed, thereby, revoking the signed hash 210 and previous CE source public RSA key. The previous CE source public RSA key could be used once again if the security provider 106 provides another signed hash 210 using the old CE source public RSA key, an old CPD value 202 with a new CPD address because the new address could be used to store the previously old CPD value.

The generation of the signed hash 210 is typically accomplished using the security providers' private RSA key and the chip manufacturer's supplied tool chain at the security provider's 106 trusted facility. The security provider 106 may generate the signed hash 210 through use of publicly available tools such as OpenSSL or custom tools developed by the security provider 106. The signed hash 210 validation in the chip 114 occurs using the security provider's public RSA key stored in the ROM/OTP of the chip 114.

As an alternative to switching CA systems, a broadcaster or service provider 102 may decide to enable the CA functionality of multiple CA systems provided by multiple distinct CA vendors 108B (e.g. CA vendor 108B1 and CA vendor 108B2) to be implemented in a single CE device 112. In this case, the broadcaster or service provider 102 may assign a single CPD 202 and CE Source public RSA key 201 to verify a CE device 112 boot image that combines the security functionality of both CA vendors 108B1 and 108B2. In this case, the boot code may combine and integrate two distinct portions, a first portion for the first CA vendor 108B1, and a second portion for the second CA vendor 108B2. Since current chip 114 designs cannot independently verify the signed hashes for two distinct boot code regions with two different public keys, a common CE source public RSA key 201 can used to verify the combined boot code portion containing the boot sequence for both CA vendors 108B1 and 108B2. In future chip 114 designs that can do so, a separate CA vendor public RSA key 201 can be used for each boot code portion.

The signed hash 210 may be incorporated in the boot flash image 152C by the CE source 108 as shown in 316 using tools provided by the chip manufacturer 104 once the CE Source 108 has finalized its own boot code. The signed hash 210 is validated in the chip 114 each time the chip 114 is powered up and before the chip 114 exits the reset mode. The precise boot process may be chip 114-specific as defined by the chip manufacturer 104.

The chip 114 may support several security provider RSA public keys, however, the number of production ROM locations available in the chip 114 is typically limited due to physical storage sizing and timing for the availability of the data (i.e. the security provider's public RSA key placed in ROM must be available at the time of the initial chip design).

As described above, one of the unique features of the present invention is the ability for a standard chip 114 to be used with a multiplicity of different CE sources 108, service providers 120 and/or CA vendors 108B, with the security features customized for each CE source 108 and/or application. Typically, there are not enough ROM hardware slots in the chip 114 for all of the possible CE sources 108 to have their security data embedded in the ROM for the production chip 114. Also, since all CE sources 108 are typically not known during the development phase of the chip 114, the security data of every CE source 108 cannot be incorporated into the more secure production ROM during the development stage. The techniques discussed below extend the public RSA key of the security provider 106 as the hardware root of trust to multiple CE sources 108, service providers 102 and/or CA vendors 108B to enable in-field switching and or augmentation of CA functions implemented in the chip 114 and without the use of a black box 116. Instead, this programming system takes a generically manufactured chip 114 and binds a specific flash memory-based CE source 108-provided public RSA key 201 to a particular customer such as the CE Source 108 or service provider 102 utilizing the security provider's ROM/OTP-based public RSA key 200 as the hardware root of trust.

### Secret OTP Value (SV) Use to Protect Sensitive Data

A secret value (SV) 451 programmed by the security provider 106 can be stored in the chip 114 OTP memory 152B, and that SV 451 can be used to indirectly modify or manipulate sensitive data that is externally supplied to the chip 114. Such sensitive data can be supplied from the service provider 102 via a broadcast, a third-party CA vendor 108B, a USB port, Internet server, DVD or similar means.

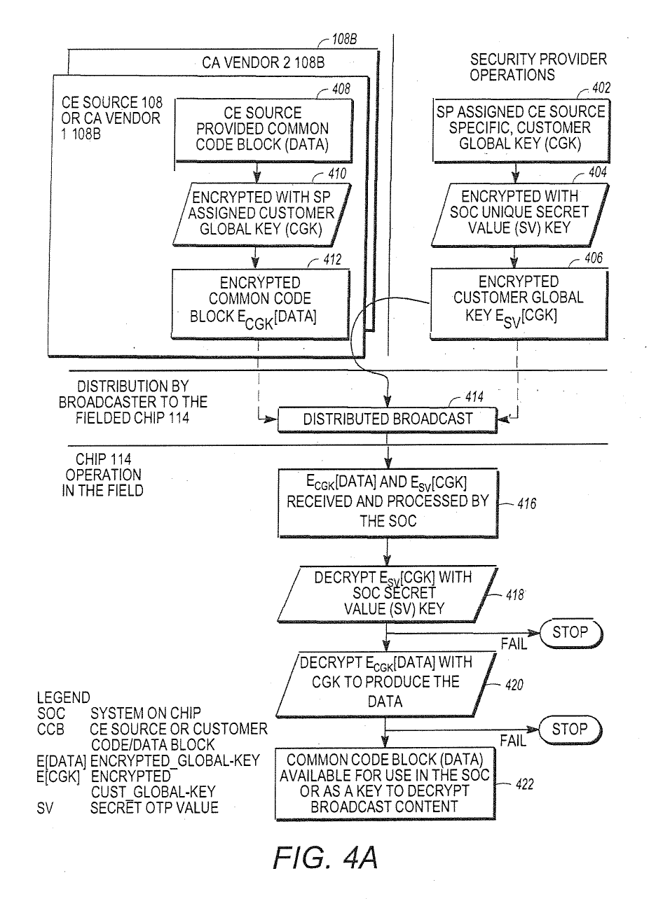

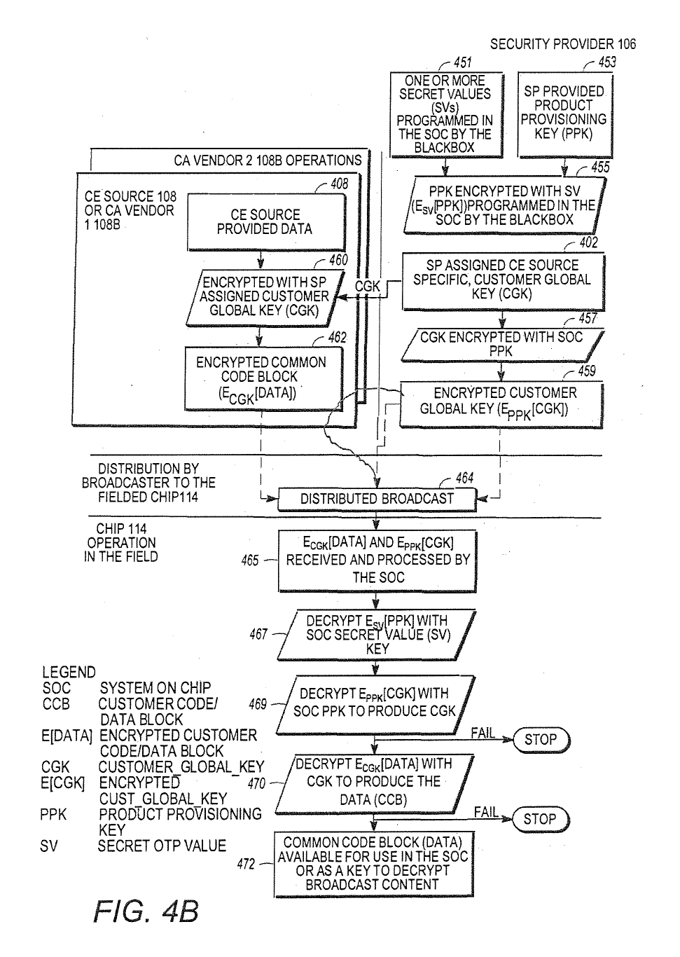

FIG. 4A and FIG. 4B are diagrams illustrating how data (D) can be securely received from one or more CA vendors 108B and can be provided for use by the chip 114 in a CE device 112. The data is protected from access by unauthorized CA vendors 108B and potential attackers. Such data (D) may be a key for decrypting media programs transmitted by the service provider 102 using the CE device 112, a common code block of data 408 including instructions for execution by the CE device 112, or similar data.

A customer global key (CGK) 402 is generated or assigned by a first entity such as the security provider 106 and transmitted to a second entity such as the CE source 108 or a first CA vendor 108B1. The data (D) 408 of interest is encrypted according to the customer global key 402 provided by the security provider 106 to produce encrypted data E_{CGK}[D] as shown in block 410. In a third-party black box programming architecture performed by the security provider 106, this encryption may be performed, for example, by the second entity or CE source 108 or CA vendor 108B. The security provider 106 may select the CGK uniquely for each CE source 108 or CA vendor 108B. Since the CGK is unique to each CA Source 108A/CA Vendor 108B, sensitive intellectual property such as code or data can cryptographically isolated and protected from successive CA vendors 108B in case switching of CA systems or vendors is desired. Such CA systems from CA vendors 108B can concurrently be implemented in the CE device 112.

In block 404, the customer global key (CGK) 402 is also encrypted according to a secret value (SV) key by the security provider 106 (or CE source 108) to produce an encrypted customer global key E_{SV}[CGK] 406. In one embodiment, each chip 114 has a unique SV key 451, and the security provider 106 or CE source 108 encrypts the CGK uniquely for each chip 114 using that chip's unique SV key 451.

The encrypted customer global key E_{SV}[CGK] 406 and the encrypted data E_{CGK}[Data] 412 are then transmitted or distributed to the CE device 112 and the chip 114, where it is received and processed, as shown in blocks 414 and 416. Transmission can be by physical transfer of a storage medium or using wired or wireless data transmission. The encrypted customer global key E_{SV}[CGK] 406 is then decrypted according to the SV key 451 stored in the chip 114 to reproduce the customer global key 402 and the encrypted data E_{CGK}[Data] is decrypted with the reproduced customer global key CGK to reproduce the data (D), as shown in blocks 418 and 420. Either or both of these operations can be performed by a third entity (for example, the user's fielded CE device 112 using the chip 114). In one embodiment, these decryption operations are hardware controlled and not accessible or modifiable by the CE device 112. It is important to note that the CGK is not shared between potential CA vendors 108B and that this cryptographic isolation is maintained in the chip 114 by encrypting the CGK with the SV key that is unique to each chip 114.

When needed, the CGK may again be decrypted using the SV key within the key ladder (a secure processing engine that handles security keys in the chip 114 without exposing such secrets to the main CPU or exporting key material for access by software) with the results of this decryption unavailable to the software of the main CPU, thereby supporting both CA switching and CA co-existence in the CE device 112.

In block 420, the decrypted CGK 402 is used to decrypt the E_{CGK}[Data] 412, resulting in the Data 408, which is used by the chip 114 to perform security related functions such as decrypting the media program. The decrypted Data 408 can also be a key used to further decrypt the broadcast content or a common block of code/data, as shown in block 422. If the operations of blocks 418 or 420 fail, processing stops, as shown in FIG. 4A. The foregoing operations can be used to transmit data from a second CA Vendor 108B2 as well.

FIG. 4B shows another embodiment of how to securely distribute data from the service provider 102 or CA vendor 108B. In this embodiment, the CGK 402 remains unique to each CA vendor 108B and cryptographic isolation is maintained in the chip 114 by use of a product provisioning key (PPK) 453 that is not shared with any other CA vendor 108B or third party. When needed, the CGK 402 is decrypted with the PPK 453 within the chip's 114 secure key processing engine that handles content protection keys, the key ladder, whose results are not available to software of the main processor of the chip 114, thereby supporting switching between CA systems (which may be supplied by different CA vendors 108B) co-existing in the CE device 112. Support for CA switching and CA co-existence is discussed in detail in the sections below.

The security provider 106 generates a secret value (SV) 451 that is unique to each chip 114 and a product provisioning key (PPK) 453 that is unique to a particular chip 114 design or model, but not unique to a particular chip 114. The PPK 453 could be changed for a given number of chips 114 programmed by the black box 116 or manufactured for a specific period of time. The SV 451 is programmed into the chip, as shown. In one embodiment, the SV 451 is securely and unalterably stored in the secure memory of the chip 114. In other embodiments discussed further below, the SV 451 may be secured by other means, for example, by incorporation within a Whitebox transmitted to the CE device.

Further, the PPK 453 encrypted by the SV 451 is also generated and programmed into the chip 114. These programming operations are performed by the chip manufacturer 104 using the black box 116 provided to the chip manufacturer 104 by the security provider 106. New keys are periodically loaded into the black box 116 which resides at the chip manufacturer 104 by encrypted DVDs or USB drive images created by the security provider 106 at their secure facility.

A customer global key (CGK) 402 is generated by a first entity such as the security provider 106 and transmitted to a second entity such as the CE source 108 or CA vendor 108B. The data (D) 408 is encrypted according to the customer global key 402 to produce encrypted data E_{CGK}[D] as shown in block 460. The encryption of the data (D) may be performed, for example, by the second entity such as the CE source 108 or CA vendor 108B.

As shown in block 457, the customer global key (CGK) 402 assigned by the security provider 106 is also encrypted according to a product provisioning key (PPK) 453 by the security provider 106, as shown in block 457 to produce an encrypted customer global key E_{PPK}[CGK] 459. The security provider 106 selects the CGK 402 uniquely for each CE source 108/CA vendor 108B combination, thus enabling the security provider 106 to support many third-party CA Vendors 108B and/or CE Sources 108 using chips 114 from multiple chip manufacturers 104 while cryptographically isolating the CGK 402 intended for use by one CA Vendor 108B1 from that used by another CA Vendor 108B2 and potential attackers by use of the PPK 453.

The encrypted customer global key E_{PPK}[CGK] 459 and the encrypted data E_{CGK}[Data] 462 are then transmitted or distributed to the CE device 112 and hence, the chip 114, where it is received and processed, as shown in blocks 464 and 465. This can be accomplished by physical transmission of media storing the encrypted customer global key E_{PPK}[CGK] 459 and the encrypted data E_{CGK}[Data] 462 or by electronic transmission of the data, by wireless or wired means since the sensitive data is encrypted. Also, the security provider 106 may transmit the encrypted customer global key E_{PPK}[CGK]459 to the CE source 108, and the CE source 108 may transmit both the encrypted customer global key E_{PPK}[CGK] 459 and the encrypted data E_{CGK}[Data] 462 to the CE device 112.

The encrypted PPK 453 is recovered by decrypting E_{SV}[PPK] that was programmed into the chip 114 using the SV programmed into the chip. This is shown in block 467. The encrypted customer global key E_{PPK}[CGK] 459 is decrypted according to the recovered PPK 453 to reproduce the customer global key CGK 402 as shown in block 469 and the encrypted data E_{CGK}[Data] is decrypted with the reproduced customer global key CGK 402 to reproduce the data 408, as shown in blocks 470 and 472. Either or both of these operations can be performed by a third entity (for example, the user's fielded CE device 112 using the chip 114). In one embodiment, these decryption operations are hardware controlled and not accessible or modifiable by the chip's main processor or any other processor associated with the CE device 112.

If the operations in blocks 469 or 470 fail, processing stops, as shown in FIG. 4B.

The decrypted data 408 is typically data that is used by the chip 114 to perform security related functions. For example, the decrypted data 408 can include a key used to decrypt the broadcast content or can be a common block of code/data for performing security related functions. The data may also comprise a media program decryption key also known as the control word (CW) and/or a pairing key (PK) that cryptographically binds the CE device 112 with an external device such as a smart card.

### Secure Product Code-Data Provisioning by Arbitrary Third-Party Customers

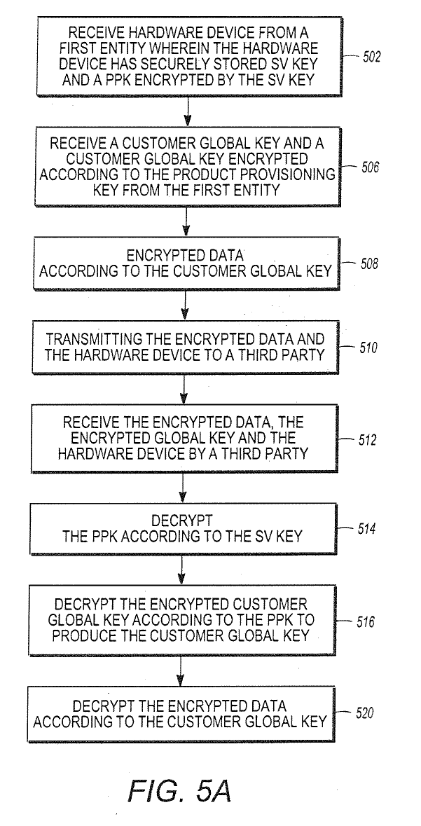

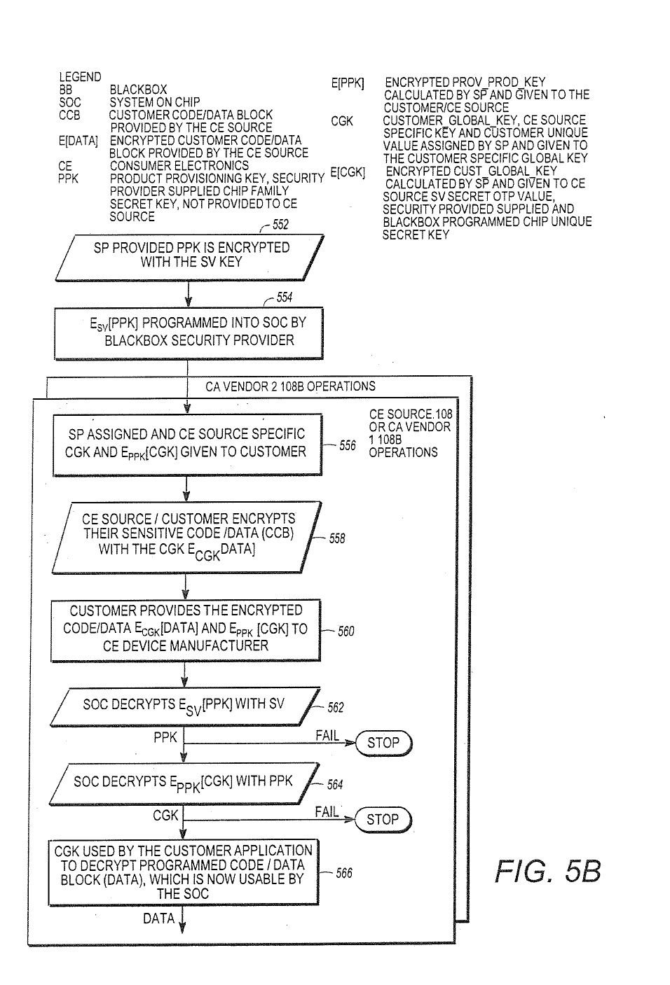

FIG. 5A is a diagram presenting illustrative method steps that can be used for the encryption of sensitive code or data to enable cryptographic separation of code and data for different CA vendors 108B and CA co-existence. The encrypted block can be provided to an untrusted consumer electronics (CE) device manufacturer 108A for provisioning.

The hardware device such as a chip 114 is received from a first entity such as the security provider 106, wherein the hardware device has a securely stored SV key 451 and a product provisioning key (PPK) 453 encrypted by the SV key (E_{SV}[PPK]), as shown in block 502. A CGK 402 and the CGK encrypted according to the PPK 453 (E_{PPK}[CGK] 459) is received from the first entity, as shown in block 506. The Data is 408 encrypted according to the customer global key to produce encrypted data (E_{CGK}[Data] 462), and the encrypted data E_{CGK}[Data] 462 and hardware device are transmitted to a third party, as shown in blocks 508 and 510. In one embodiment, the SV key and the encrypted product provisioning key E_{SV}[PPK] 455 are securely stored in the hardware device 114 via a black box 116 the first entity.

The encrypted data E_{CGK}[D] 462, the encrypted customer global key E_{PPK}[CGK] 459, and the hardware device 114 are received by the third party such as a CE Source or CA vendor 108B, as shown in block 512, and installed into the CE device 112.

The encrypted product provisioning key E_{SV}[PPK] 455 is then decrypted according to the SV key 451 stored in the chip 114, as shown in block 514. The encrypted customer global key E_{PPK}[CGK]459 is then decrypted according to the decrypted PPK 453 to produce the customer global key CGK 402, as shown in block 516. Finally, the encrypted data E_{CGK}[Data] 462 is decrypted according to the customer global key, as shown in block 520. The data is then available for use.

FIG. 5B is a diagram showing a specific example of the operations presented in FIG. 5A. The security provider 106 defines a PPK 453 and an SV 451, and programs the PPK 453 encrypted by the SV key 451 into the chip 114, as shown in blocks 552-554. This is accomplished via the security provider's black box 116 disposed at the chip manufacturer 114. Typically, the PPK 453 is held secret and not exported to software in the CE device 112, which would leave it vulnerable to unauthorized attack.

The security provider 106 then provides each CE source 108 (i.e. CE manufacturer 108A/CA vendor 108B combination) with a different customer global key, CGK 402 (in one embodiment, a 128 bit value) and the CGK 402 encrypted with the PPK 453, referred to as the E_{PPK}[CGK], as shown in block 556.

The CE source 108 encrypts their sensitive code/data (D) 408 with the CGK 402, as shown in block 558, and provides the encrypted code/data to the CE manufacturer 108A during CE device manufacturing for the initial load, as shown in block 560. The chip 114 decrypts E_{SV}[PPK] to obtain the PPK, and decrypts the E_{PPK}[CGK] using the obtained PPK 453 to produce the CGK 402, which is thereafter usable by the third-party software application such as CE device 112 or a Set Top Box (STB) User Interface (UI) code executing in the chip 114, as shown in blocks 562-566. This allows the CGK 402 to be unique to each CE Source 108 (CE manufacturer 108A/CA Vendor 108B) combination without revealing the PPK external to the security provider 106 and assures that the CGK 402 is known only to the CE Source 108 combination it is assigned to and no other party, excepting the security provider 106, which assigned the CGK 402. This enables the PPK 453, CGK 402, and SV 451 from distinct CA vendors 108B to be used independently without exposing these keys or other data to other CA vendors 108B or third parties. As a consequence, different key sets (E_{PPK}[CGK] 459 and CGK 402) can be allocated to each CA vendor 108B. This permits a plurality of CA vendors 108B to implement CA functionality on a single chip 114.

Using this process, the CA vendor-specific CGK 402, the protected code/data segment 408 and the global PPK 453 are not exposed outside the hardware controlled key ladder of the chip 114, which is the secure key processing engine that handles content protection keys. Again, the PPK 453 is held secret by the security provider 106 and not given to the chip manufacturer 104 or any third party and the CGK 402 is never given a third party outside the CE source 108 or CA vendor 108B.

Among the advantages of this scheme include:
(1) The global chip 114 secret, PPK 453, is not given to the chip manufacturer 114 or any third party. It is held secure by only the security provider 106;
(2) Each CE source 108 or CE manufacturer 108A/CA vendor 108B combination receives their own provisioning key, CGK 402; and
(3) A hardware chip 114-unique secret (SV 451) is used as the root of trust, and each CA vendor 108B can be provided a different SV key when several chip unique SVs are provisioned in the chip 114 during black box 116 manufacturing.

In one embodiment, the security provider's programming is tied to a particular chip 114 identified by a public value referred to as a Product Identifier (PID) 600. The chip 114 is uniquely programmed and provisioned by the security provider's black box 116 and tracked by the chip manufacturing process. The programming methodology taught in this disclosure enables the placement of secondary provisioning/activation server at third party CE product manufacturing facilities 108A to track actual CE devices 112 produced and tested as opposed to chips 114 manufactured by the SOC chip manufacturer 104. This secondary provisioning/activation server can be located in the CE Source Operations of FIGS. 4A and 4B. The programming methodology taught in this disclosure can automate reporting (at chip 114 fabrication and CE device 112 manufacturing) and less is hands-on for authorized third parties to track production of CE devices 112 for accounting purposes such as determining royalty payments for software licensing. This solves a major problem for CE manufacturers 108A who may not be receiving accurate reports from suppliers or distributors for royalty payment purposes for licensed software or hardware that the CE manufacturer 108A is due.

The other significant advantage with this architecture is that security is enforced purely in hardware, which is significantly harder to defeat than software-based implementations. Hardware based storage, which cannot be modified by a third-party customer or an attacker, can be used for the security provider's Public RSA or security provider's ECC key, CPD field 202, first secret value (SV) 451, one or more additional secret values (SV2, SV3, SV4, etc.), product identifier (PID) 600, JTAG unlock and E_{SV}[PPK] 455 (the PPK encrypted with the SV).

### Product Identifier (PID) Assigned to Arbitrary Customers

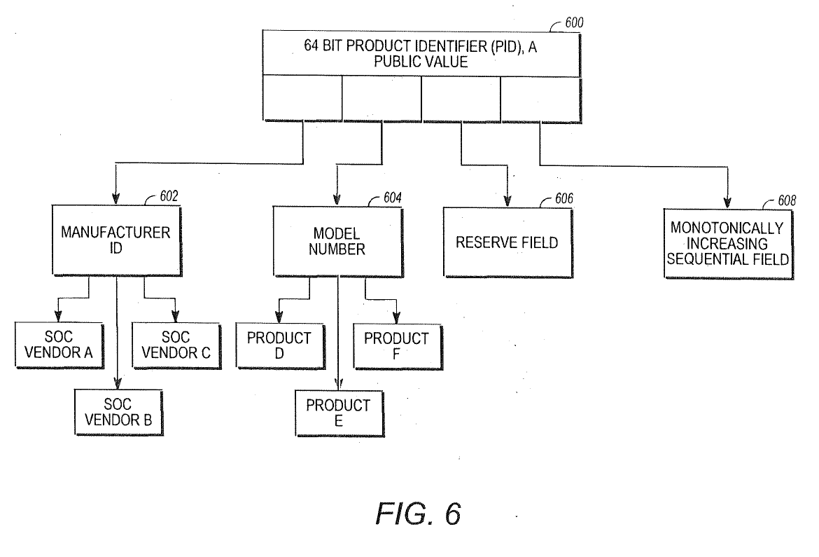

FIG. 6 is a diagram of one embodiment of the product identifier (PID) 600 described above. The PID 600 identifies the specific chip 114 (not just the chip 114 configuration), and may be provided to the CE source 108 after the chip 114 is manufactured. In one embodiment, the PID is a 64-bit Public CE Device ID that is generated by the security provider 106 and programmed in the chip 114 by the black box 116.

The security provider 106 ensures that the PIDs 600 are globally unique across all supported products, that is, across multiple chip manufacturers 104 and multiple CE device manufacturers 108A. A system-wide unique value is needed to ensure that any manufactured chip 114 can be allocated to any customer.

In one embodiment, the PID 600 consists of a chip manufacturer identifier 602, a model number 604 that specifies the type of chip 114 produced by that chip manufacturer 104, a reserve field 606 for future use and a monotonically increasing serial identifier 608 to uniquely identify the chip 114 within the product family and manufacturer.

### Conditional Access System Swap with Different Key Sets

The infrastructure provided by the security provider 106 in chips 114 programmed by the black box 116 allows for a broadcaster or service provider 102 to change Conditional Access Systems (CAS) at its discretion.

In traditional systems for large CA Vendors 108B, the Conditional Access provider held the root RSA key used to sign the boot loading code. The boot loader code, which is used by the Set Top Box (STB) or CE device 112 internal software to validate and authenticate a software download it has received, performs this critical verification step. This is to ensure an authorized party provides the code. If the boot loader cannot successfully validate the code, the code received in the download message will be rejected.

The public portion of an RSA key root key is either part of the ROM mask set of the chip 114 or it is programmed into a secure portion of One Time Programmable (OTP) memory as part of the chip manufacturer's foundry process. This key can be used by the security infrastructure of the chip 114 to authenticate the download, which has been signed with the corresponding private key section of the programmed RSA key. If the signed hash 210 cannot be validated as shown in FIG. 3, then the public RSA key verified in 310 is not correct or does not match with the public portion of the RSA key (either 200 or 201), the chip 114 will not come out of reset or will not continue with its operations, depending on the security rules of the chip 114.

In the past, this RSA key signing and authentication process was held by the Conditional Access (CA) vendor 108B, which could block the broadcaster or service provider 102 from performing downloads to the fielded CE device 112 simply by not signing the code. If a broadcaster or service provider 102 wanted to change CA vendors 108B and did not get the ability to sign the code from the originating CA vendor 108B, then the only option available to the broadcaster or service provider 102 would be to change out the in-field CE device 112 with one that it did have the proper download capability. This is a prohibitively expensive proposition for most broadcaster or service provider 102, which prevents them from running their system as they wish.

In this proposed infrastructure, the root public RSA key is extended by storing the CA vendor public RSA key in flash as shown in 216. In this case the CA vendor public RSA key 201 is either held by the broadcaster/service provider 102, or by a trusted third party that acts as an escrow entity. This allows the broadcaster or service provider 102 wide latitude in operating its system if it wishes to either change out CAS vendors 108B providers or to use multiple CAS systems in the field.

This infield CA vendor 108B replacement scheme enabled by the security provider 106 for its third-party customers (i.e. service providers 102, CE source 108, and/or CA vendors 108B) utilizes a combination of the security provider 106 black box 116 programmed data and the security provider 106 assigned keys given to the third-party customer. Keys and programmed values that enable switching CA vendors include the security provider 106 ROM RSA key, Product Provisioning Key (PPK) 453, the Customer Global Key (CGK) 402, third party customer RSA key 201 signed by the security provider's 106 private RSA key 210, the Customer Product Differentiator (CPD) 202, and one or more Secret Value (SV) keys 451.

Each chip 114 contains a unique public identifier (the PID) 600 and a private symmetric provisioning key (the Product Provisioning Key (PPK) 453). The PID 600 can be freely shared with any third party while the PPK 453 is kept private by the security provider 106 and is never released to any third party and/or Consumer Electronic (CE) Source 108. The JTAG password unlocks access to debug information and is only provided if the CE device 112 experiences an in-field failure.

The security provider 106 black box 116 programs a series of Secret Values (SVs) 451 that are allocated to the individual CE source 108 and/or CA vendors 108B as the CE source 108 or CA vendor 108B requires as a part of its conditional access system to secure content distribution. If multiple SVs 451 are programmed by the service provider 102 via the security provider 106 black box 116 and distributed to the field, the service provider may later elect to provide one or more of these SVs to an individual CA vendor 108B when the CE device 112 is first used in the field or the service provider 102 can chose to save one or more SVs 451 for a subsequent CA vendor 108B switch for the fielded CE device at a later time.

These SV values 451 can both be provided by the security provider 106, i.e. 2 or more keys, and held in escrow or given to the broadcaster or service provider 102 to hold. Another option open to the broadcaster or service provider 102 is for one of the SV values 451 to be provided by the security provider 106 and the others provided by an external key source or some other CA vendor 108B.

This allows for the broadcaster or service provider 102 to have multiple CA vendors 108B operating in the field at the same time using one STB. This can be done so that the broadcaster or service provider 102 can segregate their markets by broadcast methodology (i.e. Cable, Satellite distribution, IPTV, etc.), region (i.e. different areas of a particular City or Country, or Geographic Location such as the Asia-Pacific market), or content package (High Definition Programming, Sports or Premium content) or any other market segmentation as market forces dictate.

For each CA vendor 108B, there is typically some type of code resident in the CE device 112, such as a Security Kernel, which is used to pass keys, perform certain housekeeping functions, etc. as deemed necessary by that vendor. Given that the broadcaster or service provider 102 has control over the in-field download via the public RSA root key 201, it is a simple matter to update these Security Kernels in the field.

If the broadcaster or service provider 102 knows in advance that one or more CA vendors 108B may be operating on their network, the Security Kernels could be integrated into the “Golden Image” of the CE device 112 code at the manufacturing line, thus eliminating the need to do an in-field download.

The broadcaster or service provider 102 would then be able to use the appropriate CAS infrastructure by utilizing the specific SV 451 and other associated keys for that vendor. Again, this type of flexibility is unprecedented in the Pay TV industry and is only possible utilizing the security provider 106 black box 116 programmed data and the security provider 106 assigned keys given to the third-party customer, (i.e. service providers 102, CE source 108, and/or CA vendors 108B).

### Switching CA Vendors for Fielded CE Devices

The keys and programming infrastructure found in the chip 114 as provided by an independent security provider 106 enables the fielded Consumer Electronic (CE) device 112 to change conditional access (CA) vendors 108B (hereinafter alternatively referred to as conditional access system (CAS) vendors), thus giving the service provider 102 or broadcaster more flexibility in managing their business. This can result in saving the service provider 102 a significant capital investment by using the provided security architecture (including the chip 114 and CE device 112) and downloading a new software containing an alternate CA vendor 108B application without having to replace fielded CE devices 112.

A service provider 102 or broadcaster can switch CA vendors 108B in a legacy conditional access system without swapping fielded CE devices 112 using the method specified herein. This in-field CA vendor 108B replacement scheme enabled by the security provider 106 for its third-party customers utilizes a combination of black box 116 programmed data and security provider 106 assigned keys given to the third-party customer (i.e. service providers 102, CE source 108, and/or CA vendors 108B). Keys and programmed values that enable switching CA vendors 108B include the security provider 106 ROM RSA key, PPK 453, CGK 402, third party customer RSA key 201 signed by the security provider's private RSA key Kpr_{SP} (item 210), CPD 202, and one or more SV keys 451.

The foregoing description of describes a system boot code can be securely installed, verified, and executed in the CE device 112 and wherein data (D) used for conditional access can be securely provided to the CE device 112 for use in the conditional access system. The same procedures can be used to either provide additional conditional access functionality (e.g. to support a conditional access system provided by another CA vendor 108B) or to revoke the conditional access functionality of a CA vendor 108B and substitute that of another CA vendor 108B. Adding additional functionality to support another CA vendor 108B can be accomplished by the storage of additional security values, while revoking conditional access functionality of one CA vendor 108B to substitute another can be accomplished by replacing previously installed security values with the security values for the new CA vendor 108B.

For example, a generic bootloader 706 and/or SOC security driver can be installed in the flash memory of the System On a Chip (SOC) 114 using the procedures shown in FIG. 2 and FIG. 3 instead of the CE source 108 specific or secondary boot loader 710. This generic bootloader 706 and/or SOC security driver is capable of accepting a new customer flash application image for the CE device 112 and can authenticate a third-party public RSA key 201 associated with the new CA vendor 108B stored in the new CE device 112 flash image as shown in blocks 302-312 of FIG. 3.

The new CE device 112 application flash image includes:
A new third-party RSA key (different from the previous third-party RSA key 201 of FIG. 2), a new CPD 202 and a new E_{PPK}[CGK] 459;
New customer flash conditional access application code 316 from the same or a new CA vendor 108B with its own content protection scheme;
An optional new CE device 112 application that potentially uses new conditional access application code to implement the conditional access system; and
The security provider 106 defined code download and verification module will be included in the deployed software image.

When the CE device 112 reboots after the successful download, the new CE device application flash image is authenticated as shown in FIG. 3 with the new signed third-party RSA key as shown in 310, new CPD 202, and new CA vendor 108B application, thereby, enabling the new CA vendor 108B application to take control of the CE device 112 and provide content protection services for the service provider 102.

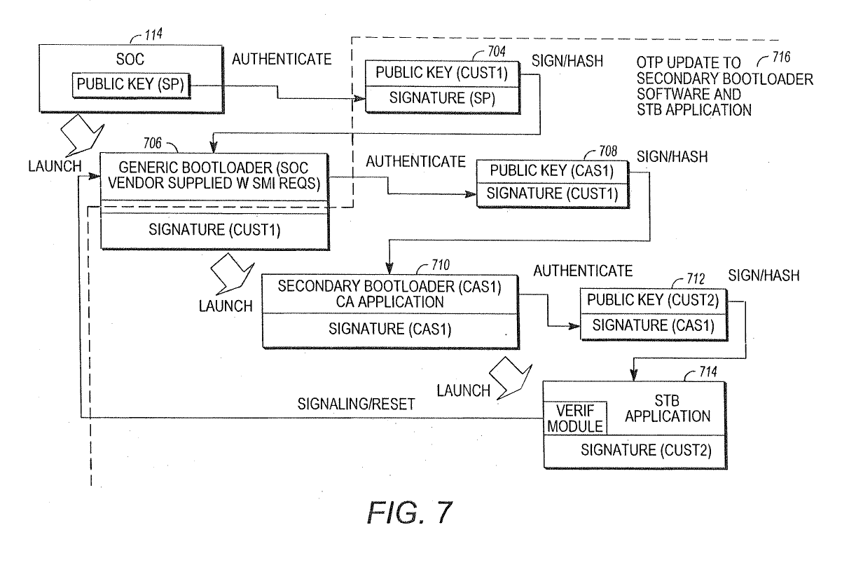

FIG. 7 shows a bootloader cascade beginning with the generic bootloader 706 authorizing the secondary bootloader 710 supplied by a CAS provider that in turn authorizes a STB application. The generic bootloader 706 is generally not replaced in the field. This bootloader 706 verifies Customer RSA key 201, i.e. Cust1 as shown in 708. The generic bootloader 706 does not contain the CAS vendor's 108B public RSA key 201. The generic bootloader 706 needs to be able to point to a new Over-the-Air (OTA) image 716 provided by the CAS vendor and load this image if the new image passes RSA Signature verification from FIG. 3. Subsequent STB reboots will load the new CAS OTA image 716, which may contain a revised secondary bootloader 710.

A download verification module resident in the STB Application monitors and guides the download process shown in 714. The code needed to download and authenticate the new CE Device 112 image is controlled by the security provider 106 and the broadcaster/service provider 102. The download verification module shown in 714 must be incorporated into the STB code image 716 to accept updates, validate updated image and re-launch the STB application. The download verification module shown in 714 assembles data segments of the encrypted image for the OTA update 716, verifies data integrity and assists generic bootloader 706 in validating the signature. Following validation of the signature, the image 716 is decrypted and made ready for re-launching the updated CE Device 112 image.

Table I lists the data used by the CE Source 108 and/or CA vendor 108B in their typical operation in providing a secure content distribution system for their service provider 102.

TABLE I
Typical keys and data fields used in providing
a secure content distribution system

| Key and/or Security Field Name | Resident in | Who programs |
|---|---|---|
| SP Public RSA ROM/OTP key | ROM/OTP | SP 102 or |
| (from 210) | | Chip Mfg. 104 |
| Customer Public RSA key (Cust | Flash | CE Source 108 in |
| Pub RSA Key) 201 | | field |
| Customer Product Differentiator | OTP | CE Source 108 in |
| (CPD) 202 | | field |
| Hash of Customer Public RSA & | Flash | CE Source 108 in |
| CPD (Hash) | | field |
| Signed Hash of Customer RSA | Flash | CE Source 108 in |
| key and Customer Product | | field |
| Differentiator (Signed | | |
| Hash) 210 | | |
| Customer signature over signed | Flash | CE Source 108 in |
| code (Cust Sig) 218 | | field |
| One or more Secret Value (SV) | OTP | SP 102 by black |
| Key(s) 451 | | box 116 or via SV |
| | | insertion |
| Encrypted Product Provisioning Key | OTP | SP 102 by black |
| (E_{SV}[PPK]) 455 | | box 116 |
| Encrypted Customer Global Key | Flash | CE Source 108 in |
| (E_{PPK}[CGK]) 459 | | field |
| Secret Value 2 (SV2) Key 451 | OTP | CE Source 108 in |
| | | field |
| Product ID (PID) 600 | OTP | SP 102 by black |
| | | box 116 |
| JTAG unlock key | OTP | SP 102 by black |
| | | box 116 |

Table II shows what keys and data fields in a particular CE device 112 are fixed (do not change) after a new software image containing an alternate conditional access vendor application has been downloaded and authenticated by the chip 114.

TABLE II
Fixed key and data fields when accepting a new software image
for an alternate conditional access vendor application
Fixed Keys/Security Fields for all downloaded
images used in the CE Device 112

SP Public RSA key (stored in ROM or
OTP) (block 200)
SV, SV_{CA2}, SV_{CA3}, SV_{CA4}, . . .
(programmed by black box) 451
E_{SV}[PPK] 455
PID 600
JTAG

The PID 600 is a public identifier and can be freely shared with any third party. The PPK 453 is kept private to the security provider 106 and is never released to any third party and/or CE Source 108 (an encrypted version of the E_{SV}[PPK] 455 is stored in the chip 114, via the black box 116 as is the secret value (SV) 451 needed to decrypt the E_{SV}[PPK] 455). The JTAG value is only provided if the CE device 112 experiences an in-field failure. Table II also shows different values of the SV key 451. The first value SV 451 is the value programmed by the security provider 106 via the black box 116 and is allocated to the individual CE source 108 and/or CA vendors 108B as the CE source 108 or CA vendor 108B requires as a part of its conditional access system to secure content distribution. SV_{CA2} is distinguished from SV2 451, which can be optionally programmed by the black box 116). Hence, if multiple SVs 451 are programmed by the service provider 102 via the black box 116 and distributed to the field, the service provider 102 may later elect to provide one or more of these SVs 451 (e.g. SV) to an individual CA vendor 108B when the CE device 112 is first used in the field or the service provider 102 can chose to save one or more SVs 451 (SV_{CA2}, SV_{CA3}, SV_{CA4} . . . ) for a subsequent CA vendor 108B switch for the fielded CE device 112 at a later time.

The downloaded STB image contains the switchable keys from Table III, i.e. the initial image loaded in the STB flash contains CA Vendor key set 0 as defined below:
Cust Pub RSA Key0
Hash0
Signed Hash0
Cust Sig0
E_{PPK}[CGK0]

CA switch means that the new STB flash for the new STB application contains an image that has values for CA Vendor key set 1. The Code Signing verification routine needs to reference these fields from the STB flash image.

Table III shows the new key and data fields that utilized when a new CE device image implements a switch from one CA vendor 108B to another CA vendor 108B.

TABLE III
New Key and Data Fields Utilized in a CE Device
After a Switch to a Different CA Vendor 108B
or Different Conditional Access System

| Keys/Security | Downloadable | Downloadable | Downloadable |
|---|---|---|---|
| Fields | Keys/Security | Keys/Security | Keys/Security |
| contained in | Fields modified | Fields modified | Fields modified |
| the initial | in first CA | in second CA | in third CA |
| image loaded | provider switch | provider switch | provider switch |
| into the CE | image delivered | image delivered | image delivered |
| Device at | to the fielded CE | to the fielded CE | to the fielded CE |
| Manufacturing | Device | Device | Device |
| SV1 | SV2 | SV3 | SV4 |
| Cust Pub RSA | Cust Pub RSA | Cust Pub RSA | Cust Pub RSA |
| Key0 | Key1 | Key2 | Key3 |
| (201) | (201) | (201) | (201) |
| CPD0 | CPD1 | CPD2 | CPD3 |
| (202) | (202) | (202) | (202) |
| Hash0 | Hash1 | Hash2 | Hash3 |
| Signed Hash0 | Signed Hash1 | Signed Hash2 | Signed Hash3 |
| (210) | (210) | (210) | (210) |
| Cust Sig0 | Cust Sig1 | Cust Sig2 | Cust Sig3 |
| (218) | (218) | (218) | (218) |
| E_{PPK}[CGK0] | E_{PPK}[CGK1] | E_{PPK}[CGK2] | E_{PPK}[CGK3] |
| (459) | (459) | (459) | (459) |

Each CA vendor 108B switch results in the installation and use of a new Customer Public RSA key 201 (i.e. Cust Pub RSA Key1, Cust Pub RSA Key2, Cust Pub RSA Key3 in the Table III). The security provider 106 assigns each new CA vendor 108B a unique CPD 202 (i.e. CPD1, CPD2, CPD3 in Table III). The security provider 106 hashes the Customer Public RSA key 201 and CPD 202 producing unique hash values and signs each new hash with the security providers 106 own Private key as requested by the service provider 102. (i.e. Signed Hash1, Signed Hash2, Signed Hash3 in Table III). To optionally further increase security, the address location for the flash-based third-party public RSA key 201 and/or the CPD 202 can also be used fix input data for a given CE source 108 and incorporated into the signed hash block 210. The secret values (SVs) 451 programmed by the black box 116 during SOC manufacturing are allocated as determined by the service provider/broadcaster 102 or CE device 112 owner. In Table III a different SV value 451 is allocated to the CA vendor 108B after a switch is performed.

The security provider 106 also assigns a new CGK 456 and generates the E_{PPK}[CGK] 459 for each switch to a new CA vendor 108B or different conditional access system. Upon a successful download and a CE device 112 reboot, the new CE device 112 application flash image 716 is authenticated with the new signed Third-Party RSA key 210, new CPD (202), and new CA vendor 108B application 716 as shown in FIG. 3. This enables the new CA vendor 108B application to take control of the CE device 112 and provide content protection services for the service provider 102 with the conditional access system new CA vendor 108B.

An existing CE vendor's 108B conditional access data can also be revoked. This is made possible by incorporating the CPD 202 into the signed hash 210 to enable the CE source 108 to revoke a previously assigned CE source 108 public RSA key 201. In this embodiment, the CE Source 108 provides a new public RSA key 201 to the security provider 106. The security provider 106 assigns a new CPD 202 to be used with the new public RSA key 201, with the new CPD 202 to be stored at the same address as the CPD 202 currently stored and used with the existing public RSA key 201. If the replaced CPD 202 was stored in OTP, then a few bits of the new CPD 202 may be changed so that the physical address of the CPD 202 does not change. The security provider 106 returns a new signed hash 210 for the new CE source public RSA key 201 and new CPD 202. The CE source 108 transmits a new software image 716 to the CE device 112 (for example, by wireless means). The previously signed CE source public RSA 201 key will no longer be successfully validated by the security provider's signed hash 210 since the signed hash uses old CPD 202 value, which will no longer pass the verification process in blocks 304-312 of FIG. 3 since the CPD 202 value has changed, thereby, revoking the signed hash and previous CE source public RSA key 201 in the CE Device 112. The previous CE source public RSA key 201 could be used once again if the security provider source provides another signed hash 210 using the old CE source public RSA key, old CPD value 202 with a new CPD address since the CPD value 202 at the old CPD address location has been changed.

TABLE IV
Provisioning for CA Co-Existence

| Keys/Security Fields | Keys/Security Fields |
|---|---|
| allocated to CA Vendor 1 | allocated to CA Vendor 2 |
| loaded into the CE Device at | loaded into the CE Device at |
| Manufacturing | Manufacturing |
| Cust Pub RSA Key0 201 | Cust Pub RSA Key0 201 |
| CPD0 202 | CPD0 202 |
| Hash0 | Hash0 |
| Signed Hash0 210 | Signed Hash0 210 |
| Cust Sig0 218 | Cust Sig0 218 |
| SV1 451 | SV2 451 |
| E_{PPK}[CGK1] 459 | E_{PPK}[CGK2] 459 |

Table IV shows a provisioning example where two CA vendors 108B can coexist in the same CE device. A common Customer private RSA key signs the final CE Device binary image containing the production code 716. The CE Device 112 would verify the signature using the Cust Pub RSA Key0 shown in 708 contained in the image 716 loaded during CE Device manufacturing or sent over the air. In this case the Customer who holds/generated the code signing RSA key 201 would be the CE Device 112 owner who is responsible for the overall operation of the STB or CE Device and the Co-existence of both CA vendors 108B in the field. The CE device 112 owner would be responsible for receiving the final binary images from the two CA vendors 108B and making sure that the applications 716 perform properly together. Each CA vendor 108B maintains its own Secret Value key 451 (SV1 and SV2 respectively) programmed by the black box 116 during SOC manufacturing that protects content related items such as Control Words and subscription entitlements. Each CA vendor 108B also is provided with its own Customer Global Key 402 (CGK1 and CGK2 respectively) that is used to protect sensitive code and CE Device data contained in the application code image 716. CA Co-Existence works in a single CE Device 112 because each CA vendor's 108B content protection mechanism is cryptographically protected and isolated against the other through the allocation of independent key sets (SV1/E_{PPK}[CGK1] and SV2/E_{PPK}[CGK2] respectively) programmed by the black box 116. The CA vendor 108B designs their unique content protection and distribution architecture based on these root keys resident in the CE device 112. Since the root key sets shown in Table IV are unique and separate for each CA vendor 108B, encrypted subscription entitlements and control words can be delivered uniquely to the CE Device 112 without fear of them being manipulated or falsely created by the other CA vendor 108B.

### Chip Ownership Validation Code for JTAG Unlock Value

In one embodiment, service provider 102 uses a key to protect a Joint Test Action Group (JTAG) port on the chip that is used to obtain access to higher security areas of the chip 114 (e.g. the chip's internal states). The value for this key can be programmed by the black box 116 during chip 114 manufacturing. In one embodiment, the key is a 128-bit JTAG key. The JTAG key should be a 128-bit value. Smaller values JTAG key lengths are acceptable if there is a delay function between successive password unlock attempts. For adequate security, the key length should be at least 64 bits in length. Access to the JTAG port is gained when the password is supplied. This key cannot be exported to software.

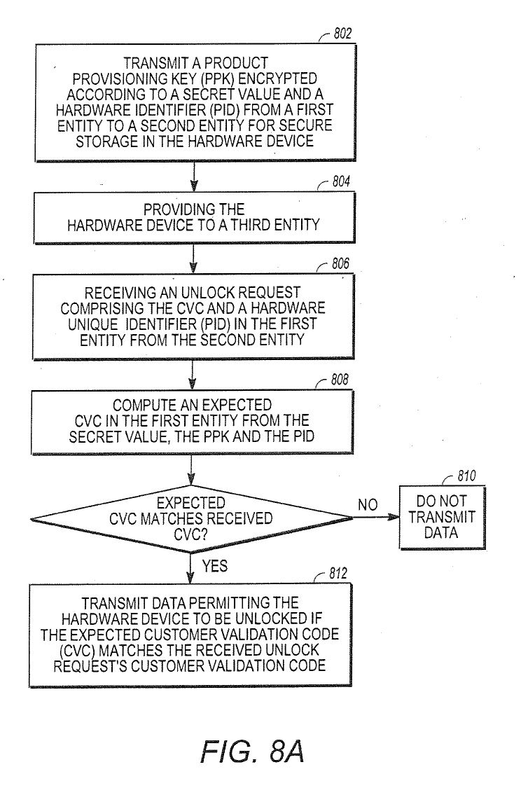

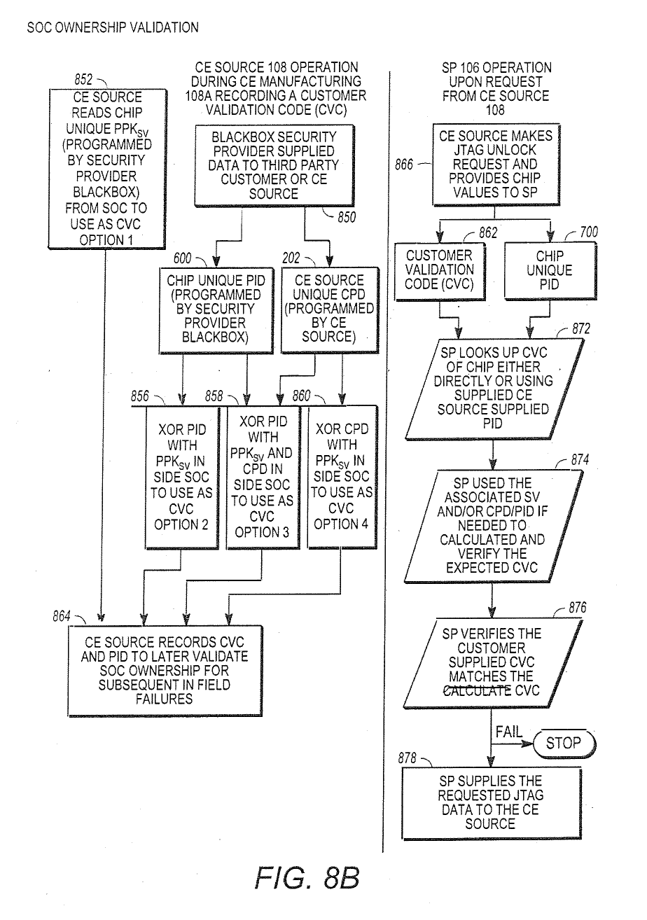

FIG. 8A is a diagram presenting exemplary method steps that can be used as a method for a first entity (service provider 106) to deliver JTAG data to unlock the hardware device or chip 114 to a second entity (CE source 108). The chip 114 ownership by the second entity can be verified by the first entity if the second entity delivers an authentication value produced uniquely for each chip 114 as recoded during the manufacturing process. There are numerous methods that can be employed several of which are identified here.

FIG. 8A is a diagram illustrating exemplary method steps that can be used to deliver the unlocking data. As shown in block 802, a product provisioning key that has been encrypted with the chip 114 unique secret value SV 451 is transmitted from the first entity (the service provider 102) to the second entity (CE source 108) for secure storage in the chip 114. In one embodiment, this is accomplished via the Black box 116. A chip 114 PID 600 is also stored in the chip 114. The chip is provided to the CE Source, which installs the chip 114 in a CE device 112, and provides the CE device 112 with the chip 114 to third parties, such as end users, as shown in block 804. When the CE device wishes to unlock the hardware chip using JTAG or similar data, the CE source 108 and transmits, and the service provider 102 receives an unlock request, as shown in block 806. The unlock request comprises a customer validation code CVC 862 that is computed by the chip 114 and reproducible in the service provider 106 as well as chip 114 identifying information such as the PID 600. In one embodiment, the CVC 862 computed in the hardware device from the encrypted product provisioning key E_{SV}[PPK] alone or with an additional seed. In other embodiments, the CVC 862 is also computed using the CE source 108 unique customer product differentiator (CPD 202), the chip 114 unique PID 600. The service provider 102 receives the unlock request having the CVC 862 and PID 600, and computes an expected CVC 862 from the secret value SV 451, and CPD/PID/PPK as required, as shown in block 808. The resulting expected CVC 862 is compared to the CVC 862 received from the CE source 108 in the unlock request, and if the two values match, the service provider 102 transmits the requested JTAG data to the CE Source 108, as shown in block 812. Otherwise, data is not transmitted, as shown in block 810. The CE Source can then use that data to unlock the chip 114 as desired.

FIG. 8B illustrates a more specific example of the calculation and distribution of customer validation data by the CE source 108 after the chip 114 is manufactured. The service provider 102 can implement a chip 114 ownership validation scheme that the CE source 108 or subscriber 110 can use to prove ownership of the CE device 112 before the service provider 102 releases a JTAG key to a requesting party. The CE source 108 participates in the generation of validation codes when the chip 114 is produced.

First, the consumer validation code (CVC 862) must be determined. This can be accomplished in a number of ways.

First, since the E_{SV}[PPK] 455 itself us unique, it can be used as the consumer validation code CVC 862, as shown in block 852.

Alternatively, as shown beginning at block 850, the CVC 862 may be computed inside the chip 114 from different combinations of E_{SV}[PPK], the chip PID 600, the unique customer product differentiator CPD 202, and a seed provided by the service provider 102. For example, the CVC 862 can be computed as an XOR of the PID 600 and E_{SV}[PPK] 455, as shown in block 856, as an XOR of the PID 600, the E_{SV}[PPK] 455, and the CPD 202, as shown in block 858, or an XOR of the CPD 202 and the E_{SV}[PPK] 455, as shown in block 860. All of these CVC 862 calculations are unique to the chip 114, SV 451 and globally unique PID 600, which could only be have been produced by a single chip 114 of the entire population of fielded chips 114. The CVC 862 (alternatively referred to hereinafter as the hash validation code) and optionally the PID 600 are recorded as shown in block 864 for later use in validating chip 114 or CE device 112 ownership.

The service provider 102 needs to be able to validate third party owner of the CE device before the JTAG unlock key can be release to a third-party customer (e.g. CE source 108). The third-party customer such as the CE source 108 transmits a JTAG unlock request 866 to the service provider 102. The request includes the CVC 862 862 and PID 600 for the chip 114 for which they require a JTAG unlock key. The service provider 102 looks up the SV 451 of the chip 114 using the PID 600 supplied by the third-party customer. The service provider 102 uses the SV 451 and the PID/CPD to calculate the expected CVC 862, as shown in blocks 872 and 874. The service provider 102 verifies that the customer supplied CVC 862 matches the calculated expected CVC 862 to determine if they are the legitimate third-party owner of the chip 114, as shown in block 876. If so, the JTAG data needed to unlock the chip 114 is transmitted to the third-party customer, as shown in block 878.

### Signaling for CAS Switching and Key Derivation

It is desirable for service providers to have the capability to segment a population of CE devices 112 (hereinafter alternatively referred to as client devices 112) into a number of different groups based on CAS switching requirements. For example, a service provider may want client devices 112 of a particular generation to switch to a second CA system based upon a discovered vulnerability discovered in that particular generation of client device 112. It is especially desirable that this capability include fielded devices that are already deployed in consumer locations. This fluid ability to define and redefine groups of fielded devices allows different CAS switching paradigms to be defined, including CAS switching that occurs slowly throughout the fielded client device 112 population.

Described below is a CAS switching paradigm and a method for signaling such switching that permits groups of fielded client devices 112 to be defined and redefined as necessary, and provides a technique for signaling when and how such CAS switching should take place. In the embodiment described below, the client device 112 has previously received an appropriate application image containing a current CAS application that will be switched out and a new CAS application that will be switched in to replace the current CAS application. In this process, the CAS switching process is guided by the vendor of the middleware executing on the client device 112 (for example, the CA vendor 108B), and no direct support is required from the CAS application itself. Typically, the CAS client runs in the client device 112 on a security processor separate and peripheral from the primary CPU of the client device 112 or a trusted execution environment (TEE), while the middleware typically executes on the same CPU used for the primary CAS application.

In one embodiment, the CAS signaling and switching is performed on a client device 112 compliant with the digital video broadcasting (DVB) specifications, including “Digital Video Broadcasting (DVB): Implementation Guidelines of the DVB Simulcrypt Standard, ETSI TR 102 035, Version 1.1.1, published 2002 by the European Telecommunications Standards Institute; “Digital Video Broadcasting (DVB): Head-end implementation of DVB SimulCrypt,” ESTI TS 103 197, Version 1.5.1, published 2008 by the European Telecommunications Standards Institute; and “Common Interface Specification for Conditional Access and Other Digital Video Broadcasting Decoder Applications,” EN 50221, published February 1977 by the Technical Committee CENELEC TC 206, all of which are hereby incorporated by reference herein. In this instance, the CAS switching process involves the Application Specific Data (ASD), which is defined in the Digital Video Broadcasting (DVB) specifications as Private Data (PD). CAS switching data is inserted by the service provider 102 (hereinafter alternatively referred to as the headend 102) into the content delivery network (CDN) for delivery to the selected client devices 112. This data is received and processed by the middleware in the client device 112 to use the appropriate CAS application as directed by the signaling mechanism described herein.

This process allows the operator of a service provider or headend 102 (COMCAST, DIRECTV, DISHTV, or ECHOSTAR, for example) to set up groups in the client device 112 population as they see fit at the time they intend to perform a switch away from the existing CAS vendor 108B to a new CAS vendor 108B whose application resides in the device. A CAS switch may be desirable in the event the exiting CAS system has been hacked, due to an expiring business relationship with the existing CAS, or more favorable business terms and/or features are available in a new CAS.

The CAS data is passed to each defined group of client devices 112 through the middleware based on the ASD. The new CAS is signaled to the middleware by a message sent from the headend 102 indicating that the middleware should begin using the new CAS. The individual SoC 114 in each client device 112 may require a reboot if required or needed to properly configure the data and key handling resources in the SoC 114. Specific SoCs 114 may be utilizing a derived key mechanism (defined below), which means that the key ladder responsible for calculating the control words used to decrypt encrypted video packets must be properly configured in the SoC 114 for a given CAS client.

The Private Data Generator (PDG) described in the DVB standard closely resembles an entitlement management message (EMM) generator, receives and processed the ASD. This implementation is independent of the CA vendor 108B of the CAS, so it is not necessary to discuss details of the CAS switching implementation or process with individual CAS vendors 108B. The CAS switch is independent of the CAS client itself as it is guided by state in the middleware implemented in the client device 112. After a switch, entitlements are delivered to the new CAS client (i.e. CAS application for the new operational CAS in the client device) for it to properly provide the subscriber with access to their paid/subscribed programming.

Typically, a CAS switch is performed during off peak viewing hours to minimize disruption in the subscriber/viewing population. However, since the switch command is a part of the same signal that delivers the content itself, a switch from one CAS to another will not occur if the client device 112 is not receiving the content delivery signal at the time a CAS switch is requested by the headend 102. Consequently, a second or third attempt to complete the CAS switch may be required before the switch actually takes place. Messages to the middleware could be repeated in a carousel fashion (similar to how electronic program guides (EPGs) are currently distributed), and contain a date/time to perform the actual switch/reboot. That increases the likelihood that all client devices 112 in the group perform the switch command at the same time, irrespective of when each client device 112 may have been tuned to the receive the content delivery signal.

### DVB Definitions

The DVB standard defines a program association table (PAT) and a conditional access table (CAT). Both the PAT and the CAT are associated with DVB program identifiers (typically referred to as PIDs, but henceforth referred to as PrIDs for purposes of distinguishing them from the processor/product IDs discusse herein) that identify each program in a data stream that may comprise multiple programs. The data stream may also comprise multiple independent program map table (PMT) sections. Each PMT section is given a unique user-defined PrID and maps a program number to the metadata describing the program and the program streams.

The PrIDs associated with each PMT section are defined in the PAT, and are the only PIDs defined there. The streams themselves are contained in packetized elementary stream (PES) packets with user-defined PrIDs specified in the PMT. The PMT is comprised of sections for each program number represented in a transport stream, each section of which contains the packet identifier and characteristics of each elementary stream in the program service. The CAT is used for conditional access management of the cypher keys used for decryption of restricted streams. The CAT table contains privately defined descriptors of the system used and the PrID of the EMM associated with that system. It is used by a network provider to maintain regular key updates.

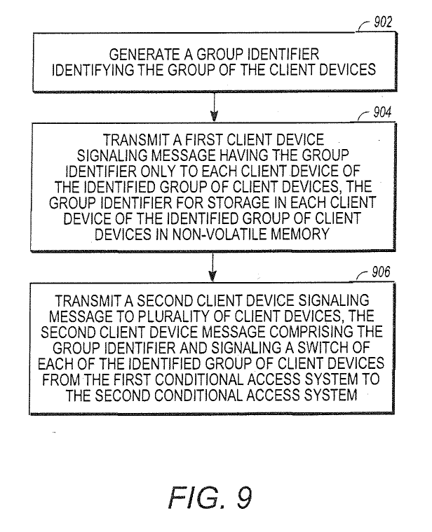

FIG. 9 is a diagram illustrating exemplary method steps for controlling a group of client devices 112 to switch from a first CAS to a second CAS via a plurality of client device signaling messages. As described below, the client device signaling messages each comprise at least one of a plurality of action codes and payload data.

In block 902, a group identifier that identifies the group of client devices 112 is generated. In block 904, a first client device signaling message is transmitted to only each client of the identified group of client devices 112 (the first client device signaling message is not transmitted to client devices 112 that are not in the identified group). The first client device signaling message includes the group identifier. The group identifier is for storage in a non-volatile memory of each client device 112 of the group of client devices 112.

In block 906, a second client device signaling message is transmitted to the plurality of client devices 112 (which may include client devices 112 that are not in the identified group). The second client device signaling message includes the group identifier and signals a switch of each of the group of client devices 112 from the first conditional access system to the second conditional access system.

In one embodiment, each of the plurality of devices comprises a middleware module, and the first client device message and the second client device message are transmitted on a conditional access switching message channel monitored by the middleware module of each of the plurality of devices. In this case, an identifier of the conditional access switching message channel (e.g. a switching message PrID) is transmitted to each of the plurality of devices, for example, in a conditional access table.

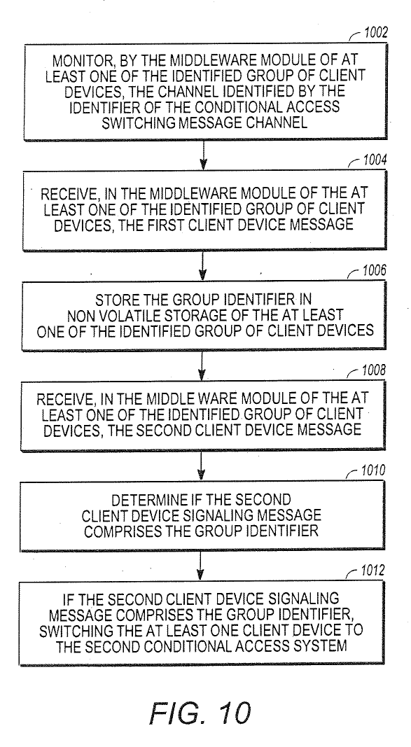

FIG. 10 is a diagram illustrating exemplary operations performed by the client devices 112 in receiving and handling the first client device message and the second client device message. In block 1002, a middleware module of at least one client device 112 of the group of client devices 112 monitors a channel identified by the identifier of the conditional access switching message channel. In block 1004, the middleware module of the at least one of the client devices 112 receives the first client device message transmitted in block 904 (which includes the group identifier). In block 1006, the group identifier is stored in non-volatile memory of the at least one of the client devices 112. The middleware of the client devices 112 continue to monitor the conditional access switching message channel, and in block 1008, the middleware module of the at least one of the group of client devices 112 receives the second client device message. Block 1010 determines whether the second client device signaling message comprises the group identifier received and stored in blocks 1004 and 1006. If so, the at least one client device 112 switches from the first conditional access system to the second conditional access system, as shown in block 1012.

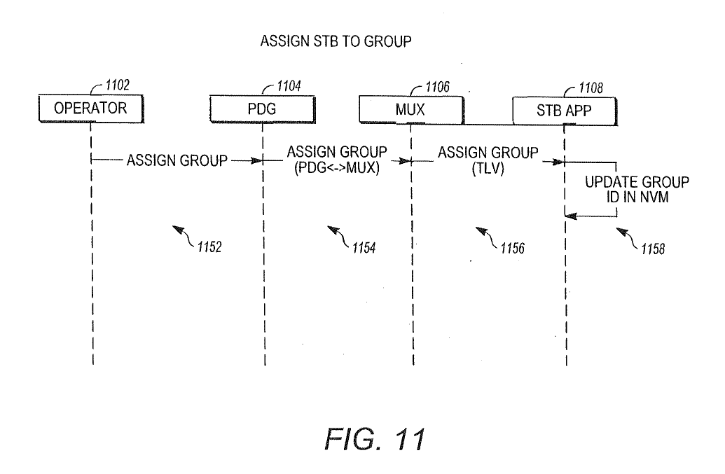

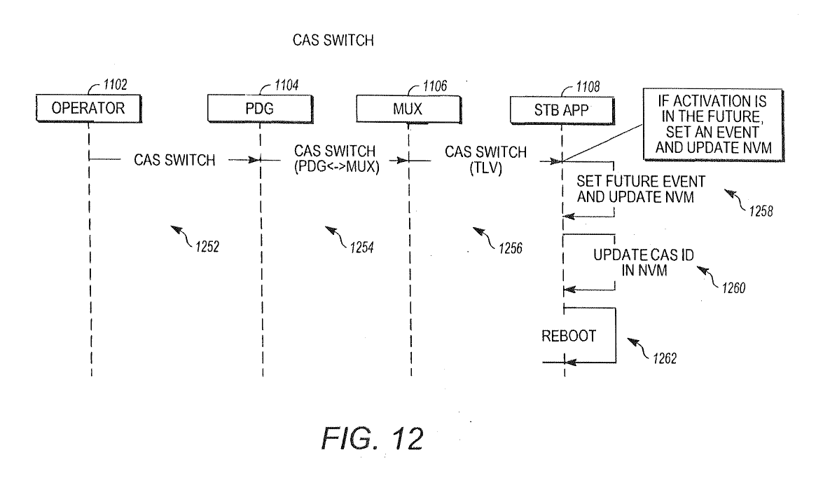

FIGS. 11-12 illustrate the operations presented in FIGS. 9-10 in greater detail.

### Assigning a Client Device to a Group

FIG. 11 illustrates operations that may be performed to assign a client device 112 to a group. This illustrates additional detail regarding the operations illustrated in blocks 902 and 904 of FIG. 9 and blocks 1002-1006 of FIG. 10.

Client devices 112 are assigned to a particular group upon activation via a group identifier stored in non-volatile memory (NVM). The group identifier allows a subset of the client device 112 population to switch to another CAS system stored in the client device, but dormant (e.g. not installed and operating). This group assignment by provision of the group identifier is in addition to the other actions that may be required by the CAS currently active in the client device. Then an application executing on the client device 112 updates the group identifier by storing it in NVM upon reception of a message having an Assign Group Action.

As shown in 1152, an operator 1102 issues an assign group command to the private generator or PDG 1104. The operator 1102 may comprise a human or a computer executing instructions to generate the command based on input from humans or another computer. As shown in 1154, the PDG 1104 generates private data comprising a group identifier, and provides this identifier to a multiplexer 1106 which multiplexes the private data having the group identifier into the data stream transmitted to the client device. The private data is then transmitted in a data stream to the client device 112 where it is accepted by the client device 112 (set top box or STB) application 1108, as shown in 1156. The client device 112 then updates the group identifier of the client device 112 by storing the received group identifier in non-volatile memory (NVM) as shown in 1158.

FIG. 12 illustrates operations that may be performed to initiate a CAS switch. This illustrates additional detail regarding the operations illustrated in blocks 906 of FIG. 9 and blocks 1008-1012 of FIG. 10.

A CAS switch 1252 from an operator 1102 is initiated by a Switch CAS message generated by the PDG 1104 as shown in 1254. The Switch CAS messages can be addressed to one or more individual client devices 112, a group of client devices 112 or all client devices 112. This paradigm permits a single message to be sent to all client device 112 members in the group as opposed to sending many single, independent messages to individual client devices 112. The Switch CAS message may include an activation date to allow pushing of the message before the CAS switch is to actually take place. In such cases where the activation date/time is in the future, the STB application 1108 executing in the client device 112 sets an event and writes the CAS ID to an NVM memory location for future use by the CAS Switch activation event. When the activation event occurs (in the future or immediately), the STB application 1108 writes the CAS ID to a well-known location memory location in NVM (that is designated to be executed on reboot) and reboots. On reboot, the STB application 1108 reads the CAS ID and activate the corresponding CAS kernel to install and execute the new CAS.

Referring to FIG. 11, the operator 1102 selects which group of the client devices 112 are desired for a CAS switch, an identifier of the CAS to be switched to (CAS ID) and issues a CAS switch command identifying these devices and providing the CAS ID, as shown in 1202. In 1254, the PDG generates private data comprising the group number of the group of client devices 112 for which the CAS switch was desired, and provides that PDG to the multiplexer 1106, which multiplexes the private data having the group identifier and information indicating that a switch is desired into the data stream as a CAS switch command. The private data is then transmitted in a data stream to the client device 112 where it is accepted by the client device application 1108, as shown in 1258. As described further below the CAS switch may be performed immediately upon receipt by the client device, or may be performed as a future event. In cases that the update is to occur immediate, the CAS ID is updated in NVM, and the client device 112 is rebooted as shown in 1260 and 1262. In cases where the update is to occur at a later time or date, the CAS ID is updated in NVM, and a future event is set, at which time the CAS switch will take place by rebooting 1262 the client device.

### Client Device Operations to Perform CAS Switch

As a part of the booting process, middleware executing on the client device 112 checks the known flash location (designated to be executed on reboot) to determine which CAS to initialize. This information was included in the form of the CAS ID (for example, CAS-A, CAS-B or CAS-C) transmitted with the CAS Switch message described above. Next, the middleware executing on the client device 112 provides CAS specific data to a secure processor of the client device 112 (e.g. a SoC 114 or system on a chip) so that the SoC 114 can derive keys associated with the selected CAS and pertaining to the appropriate CAS vendor 108B. Such keys may include, for example keys or intermediate results required to derive keys for decrypting media programs encrypted by the headend 102.

Next, the middleware executing on the client device 112 initializes the appropriate CAS, which then operates as a CAS client. The middleware monitors the appropriate channel to receive the CAT from the headend 102, and once the CAT is received, the middleware passes the CAT to the CAS client.

Using the CAT, the CAS client instructs the middleware to monitor the appropriate channel to receive EMMs. The appropriate channel can be defined according to a particular DVB PrID, which may be placed in the CAT with a “dummy” CAS identifier. For example, in a DVB system, the PrID used for EMM reception may be monitored.

When the client device 112 is tuned to the appropriate channel, the middleware receives the PMT and parses the PMT to determine the PrID of the ECMs that correspond to the CAS currently in operation (e.g. the CAS recently switched to). The middleware then filters the incoming data stream for ECMs having the determined PrID, and passes those ECMs to the CAS client. The CAS client (cooperating with the middleware if necessary) then process the ECM to load decrypting information such as keys and/or software, and uses that information to generate keys or other information that is needed to decrypt media program(s).

### Message Definitions

This section provides an exemplary format and syntax of the messages communicated with the client device. It is noted that message of differing format and/or syntax may be used. In a preferred embodiment, the messages themselves are cryptographically protected, either through encryption, hashing or other means.

Messages communicated with the middle ware include (1) an address (intended target of message, such as global, group, specific), (2) a sequence number (to prevent duplicate processing), (3) a message type, and (4) payload. Message types include but are not limited to (1) Assign group, (2) Assign CAS Vendor 108B, and (3) Reboot. Payloads are specific to a particular message type, as further described below. Based on message type, middleware will take appropriate action (i.e. store group info in flash, store selected CAS vendor 108B in flash, reboot at the appropriate time).

Message include an action code, describing a particular action that the message is to command. In the example below, actions are embedded in the message in a tag-length-value (TLV) format.

### Action Table

Table V defines one embodiment of a minimal list of Actions to implement for CAS Switching messages.

TABLE V

| Action | | |
|---|---|---|
| (Hex) | Description | Comments |
| 01 | Sequence number | Sequence number of the message |
| 02 | Time stamp | Timestamp of the message in system time |
| 10 | Unique Addressing | Unique address of STB |
| 11 | Group Addressing | Group address of STB |
| 12 | Global Addressing | All STB's |
| 20 | Assign Group | Assign a STB to an addressing Group |
| 21 | CAS Switch | Switch from current CAS to CAS |
| | | identified in the message |

Each message minimally requires the following Actions (1) Addressing (unique, group, or global) (2) Timestamp (3) Sequence number (4) Primary action (Assign Group or CAS Switch).

The Sequence Number action (01) is used communicate the sequence number of the message to the STB Application 1108. This information prevents the STB application 1108 from reprocessing messages. Data associated with this action is presented in Table VI.

TABLE VI

| Field | Size | Description |
|---|---|---|
| Action Code | 1 | 01 - Sequence Number |
| Length | 1 | Length (does not include action or |
| | | length fields) |
| Sequence Number | 2 | Sequence number |

The Timestamp action (02) is used to indicate system time. Messages with Timestamps in the past should not be processed. Data associated with this action is presented in Table VII.

TABLE VII

| Field | Size | Description |
|---|---|---|
| Action Code | 1 | 02 - Timestamp |
| Length | 1 | Length (does not include action or length fields) |
| Time | Var | User defined time |

The Unique Addressing action (10) is used to address a single client device. Data associated with this action is presented in Table VIII.

TABLE VIII

| Field | Size | Description |
|---|---|---|
| Action Code | 1 | 10 - Addressing Unique |
| Length | 1 | Length (not including action and length fields) |
| Address | var | The unique address of the STB (Transport Chip ID) |

The Group Addressing (11) action is used to address a group of client devices 112 assigned to a Group Identifier. Data associated with this action is presented in Table IX.

TABLE IX

| Field | Size | Description |
|---|---|---|
| Action Code | 1 | 11 - Addressing Group |
| Length | 1 | Length (not including action and length fields) |
| Group ID | 2 | The Group Identifier |

The Global Addressing (12) action is used to address all client devices 112. Data associated with this action is presented in Table X.

TABLE X

| Field | Size | Description |
|---|---|---|
| Action Code | 1 | 12 - Addressing Global |
| Length | 1 | Length (not including action and length fields) |
| | | Shall be 0 |

The Assign Group (20) action is used to assign a STB to a Group Identifier. Data associated with this action is presented in Table XI.

TABLE XI

| Field | Size | Description |
|---|---|---|
| Action Code | 1 | 20 - Assign Group |
| Length | 1 | Length (not including action and length fields) |
| Group ID | 2 | The Group Identifier |

The CAS Switch (21) action is used to signal a CAS Switch. Data associated with this action is presented in Table XII.

TABLE XII

| Field | Size | Description |
|---|---|---|
| Action Code | 1 | 21 - CAS Switch |
| Length | 1 | Length (not including action and length fields) |
| CAS ID | 4 | CAS ID to switch to |
| Activation | 1 | The length of the Activation Time to follow |
| Time | | |
| Length | | |
| Activation | var | The time at which the CAS Switch should occur. |
| Time | | There may be an encoding of ‘Now,’ meaning |
| | | perform CAS Switch immediately on reception. |

### Derived Key Mechanism in SoCs

The system and method described above permits programming of unique secrets into the SoC 114 at the SoC 114 manufacturing site 104 and permits later allocation of these SoCs 114 to any one of a number of potential CE device manufacturers 108A and many independent CAS/DRM vendors 108B. SoC 114 programming can also occur at the packaging or product manufacturing facility by execution of an in-field programming sequence on the SoC 114.

In traditional broadcast and cable system, content is offered to subscribers within the content distribution ecosystem directly from the service provider, i.e. satellite or cable provider. In some embodiments, a Hardware Root of Trust Security is offered for high value content with easy integration with a CAS and DRM technology to enable many content providers to provide their media programs directly to consumers using their CE devices. In both models (i.e. traditional broadcast model versus the content provider direct model) of content distribution, a security provider independent architecture can support multiple concurrent or serial CAS and DRM implementations using a single black box programming security platform with limited One Time Programming (OTP) resources to store secrets representing the hardware root of trust. This security architecture implementation provides a means for instantaneous switching between security profiles offered by different and independent CAS and DRM security providers.

In a derived key SoC architecture providing security providers with different security key debases is accomplished by allowing SoCs 114 to use black box OTP resources as the basis to derive security keys to enable different security schemes by altering the key generation inputs based on digital rights management (DRM) and CAS vendor 108B software and possibly CA vendor 108B unique OTP inputs. The key generation inputs can be provided in the CAS and DRM application that could be loaded at CE device manufacturing or downloaded over the air for fielded CE device(s).

Key derivation can be accomplished in a number of ways, for example, by taking the black box programmed secret OTP keys, CAS/DRM vendor 108B software input and possible CAS/DRM vendor 108B unique OTP values and combining in a series of crypto graphic calculations using AES, DES or Triple DES. Where the black box programmed secret OTP keys are used as the key and the software input and CAS/DRM vendor 108B unique OTP values are the data in the cryptographic operation. Such operations are standard for those skilled in use and construction of cryptographic calculations.

By changing the key generation inputs, the SoC 114 can derive unique key outputs for each CAS and DRM security provider used for a given content provider or broadcaster. CAS unique inputs such as their assigned CAS ID maybe used to differentiate derived keys for CAS1 versus CAS2. The term security provider in this context is to be broadly construed and reflects the entity who would use the derived key database for a population of fielded CE devices to protect content for purchase by an entity who had a particular CE device in their home. These security provider unique key generation outputs enable support for multiple security providers for fielded CE devices typically found in Set Top Boxes, televisions (TVs), Smart TVs and mobile devices. The black box security provider provides compatible headend applications to each content provider, so that the media programs are encrypted or otherwise protected using the CAS and DRM implementation used.

Another advantage of using a derived key database is that the black box programmed OTP key secrets programmed into the SoC 114 OTP do not have to be released to the multiple CAS and DRM security providers, since these security providers would use the derived key databases for their content protection systems. This means that if a derived key database were compromised, it only affects the specific CAS/DRM security provider that was using that specific derived key database, i.e. such compromise would not affect the fielded CE devices or derived key databases of any other such CAS/DRM security provider.

The keys and programming infrastructure summarized herein as provided by an independent black box security provider enables fielded CE devices to add additional revenue baring applications to the CE device manufacturer or content provider giving these entities more flexibility in managing their business and offering new services. Besides switching out a CAS/DRM vendor 108B for any number of reasons, enabling the ability to add applications supporting new CAS/DRM vendors 108B in fielded CE devices 112 can result in generating significantly higher content sale revenues without requiring consumers to upgrade their CE devices 112. Consumer savings are realized by extending the field life of the CE device 112 by allowing the consumer to download new software images to enable the purchase of new content services without having to replace their fielded CE devices 112.

### Integrated CAS Client as a Second and/or Dormant Backup

In many cases it is desirable to fully integrate an additional CAS client in a client device 112 such as a STB to act as a second and/or dormant backup to be used in emergency situations for business continuity purposes or as an alternative to other CAS clients that may also reside in the client device.

The operator or broadcaster must assign their content packages and products to the dormant CAS so that package definitions and entitlements can be properly assigned and allow authorization messages to be created and delivered to the STBs. Client licensing and headend 102 equipment must also be available to integrate all CAS client applications implemented in the client device 112, i.e. the primary, backup and/or dormant CAS client must be fully developed, tested and ready to integrate into the client device and middleware application so that they can be fully operational in the event they are needed to replace the primary CAS client in the deployed client device. Implementing this embodiment requires the completion of the following.

First, each CAS client must be fully integrated with the client device 112 to provide full capabilities for the second/dormant CAS system. This is to assure compatibility of the CAS system and the middleware executed by the client device. Hence, if the CAS and middleware executed by the client device 112 are from different vendors, they must assure such interoperability is maintained so that the CAS and middleware operate in an integrated manner. Such integration requires marginal additional effort for a single vendor since the CAS integration effort will be conducted for each integrated CAS client.

Second, related CAS (and middleware)-related applications executing at the headend 102 must be integrated with the CAS clients and middleware executing in the client devices 112, preferably prior or near system launch. Typically, the CAS-related headend 102 execute on servers operated by the headend 102, due to intellectual property concerns and to isolate their execution environments.

Third, a CAS switch by a limited number of fielded client devices 112 should be tested to ensure proper client device 112 operation before and after the switch.

The switch to a supported CAS client in the client device 112 may be activated using the above CAS switching protocol with no hardware modifications to the client device 112 or the headend 102 equipment. This same switching protocol can be used to switch between the any of the supported CAS clients in the fielded client devices 112, giving full access to the content protection systems for the new CAS client. Using this approach such CAS switching is transparent to the CAS application running in the client device.

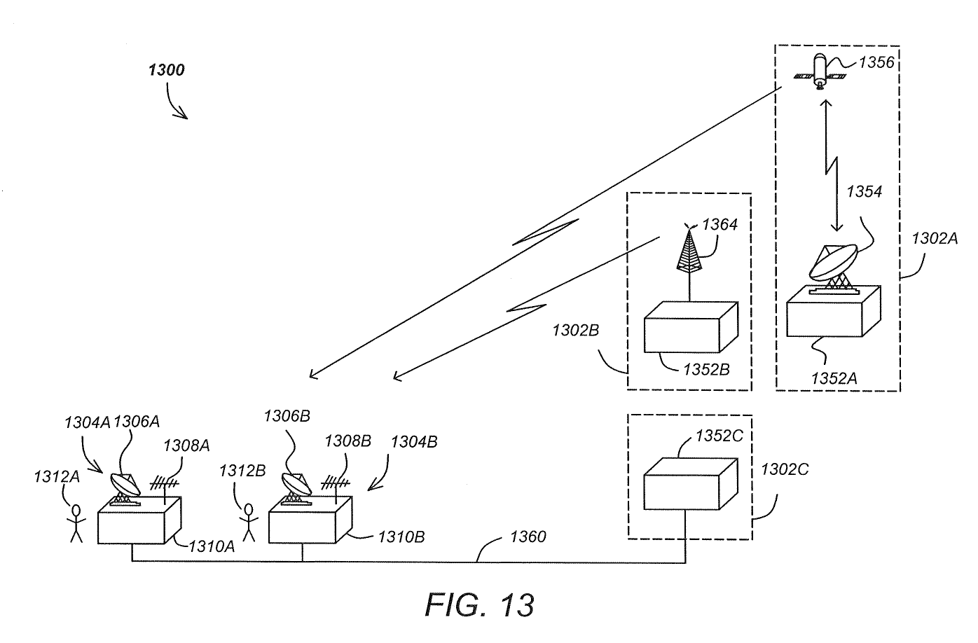

FIG. 13 is a diagram illustrating an exemplary media program distribution system 1300. The system 1300 may include one or more service providers or headends (hereinafter alternatively referred to as broadcasters) 1302 which are analogous to the service providers 102 of FIG. 1, such as a first service provider 1302A that broadcasts media programs from a satellite broadcast facility 1352A via one or more uplink antennas 1354 and one or more satellites 1356, a second service provider 1302B, that broadcasts media programs from terrestrial broadcast facility 1352B and one or more terrestrial antennas 1364, and a third service provider 1302C that broadcasts or transmits media programs by use of a cable broadcast facility 1352C via a cable link 1360 or via the Internet. The transmission of the media programs may be over substantial distances in the order of miles, or shorter distances (for example, within a motel, airplane, or ocean-going vessel).

The system 1300 also comprises a plurality of subscriber stations 1304A, 1304B (alternatively referred to hereinafter as subscriber station(s) or receiving station(s) 1304), each providing service to one or more subscribers 1312A and 1312B (alternatively referred to hereinafter as subscribers 1312). Each subscriber station 1304A, 1304B may include a satellite reception antenna 1306A, 1306B (alternatively referred to hereinafter as satellite reception antenna 1306) and/or a terrestrial broadcast antenna 1308A, 1308B (alternatively referred to hereinafter as terrestrial broadcast antenna 1308) communicatively coupled to an STB or receiver 1310A, 1310B (alternatively referred to hereinafter as receiver(s) 1310, STBs, or integrated receiver/decoder(s) (IRDs)). The receivers 1310 are analogous to the CE devices 112 of FIG. 1A.

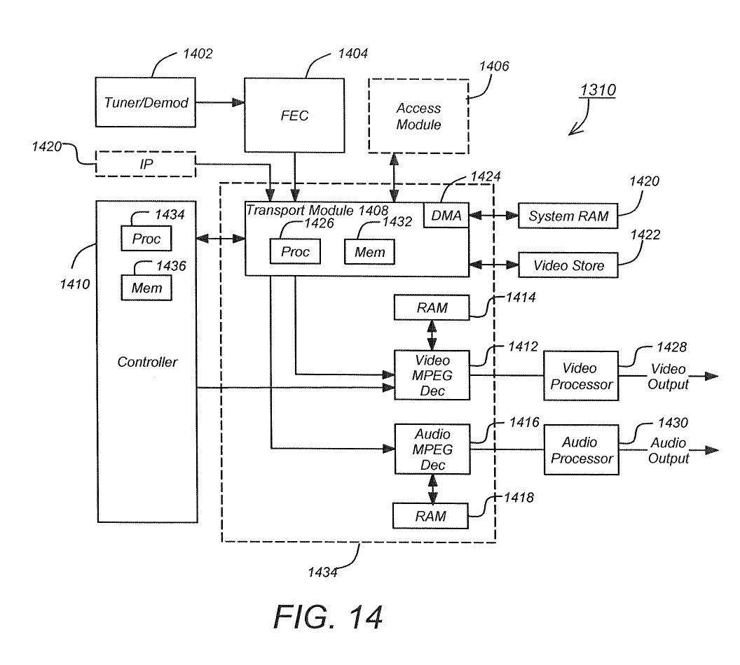

FIG. 14 is a diagram illustrating an exemplary embodiment of a receiver 1310. The receiver 1310 may comprise a tuner/demodulator 1402 communicatively coupled to the antennas 1308/106. The tuner/demodulator 1402 converts the modulated data to a digital data stream. The digital data stream may be supplied to a forward error correction (FEC) decoder 1404. This allows the receiver 1310 to correct data errors in signals transmitted using forward error correction. The error-corrected data is then fed from the FEC decoder module 1404 to the transport module 1408. Alternatively, data can be received via an internet protocol (IP) link 1420

The transport module 1408 performs many of the data processing functions performed by the receiver 1310. The transport module 1408 processes data received from the FEC decoder module 1404 and provides the processed data to the video decoder 1412 and the audio decoder 1416. The transport module 1408 also provides a passage for communications between the main processor 1434 and the video and audio decoders 1412, 1416. The transport module 1408 also operates with the access module 1406 to determine whether the subscriber 1312 is permitted to access certain program material. The operations performed by the transport module 1408 may be controlled by the controller 1410 and are further illustrated and described below.

Typically, one or more media programs are transmitted to the receiver 1310 in a time division multiple access (TDMA) packet-based transport stream that transports one or more media programs. Packets belonging to one particular media program are distinguished from other packets via an identifier such as a program identifier as described in the MPEG protocol or a channel identifier (CID). In receiving a particular program, the transport module 1408 assembles the packets having a particular program identifier or CID associated with the selected media program or channel, and provides those assembled packets to the video decoder 1412 and the audio decoder 1416 to produce the video output 1428 and the audio output 1430.

In one embodiment, the packets representing the media program are encrypted according to a secret or key (K), and an access card 1406 removably coupleable to the receiver 1310 is used to decrypt the packets so that the media program may be presented. In one embodiment, the transport stream includes key packets that are transmitted to the receiver 1310. The transport module 1408 separates these key packets according to the appropriate packet identifier, and sends them to the access module 1406. The access module 1406 decrypts the key packets to produce the keys needed to decrypt the associated media program packets and provides those decryption keys to a descrambler in the transport module 1408. These decrypted packets (which include video and audio data embodying the decrypted media program) are provided to the video decoder 1412 and audio decoder 1416.

Video data is processed by the video decoder 1412. Using the video random access memory (RAM) 1414, the video decoder 1412 decodes the compressed video data and sends it to an encoder or video processor 1428, which converts the digital video information received from the video decoder 1412 into an output signal usable by a display or other output device. By way of example, processor 1428 may comprise a National TV Standards Committee (NTSC) or Advanced Television Systems Committee (ATSC) encoder. In one embodiment of the invention both S-Video and ordinary video (NTSC or ATSC) signals are provided. Other outputs may also be utilized, and are advantageous if ATSC high definition programming is processed.

Audio data is likewise decoded by the audio decoder 1416. The decoded audio data may then be sent to a digital to analog (D/A) converter 1430. If desired, additional channels can be added for use in surround sound processing or secondary audio programs (SAPs). In one embodiment of the invention, the dual D/A converter 1430 itself separates the left and right channel information, as well as any additional channel information. Other audio formats may similarly be supported. For example, multi-channel digital audio formats, such as DOLBY DIGITAL AC-3.

The video processing module 1428 output can be directly supplied as a video output to a viewing device such as a video or computer monitor. In addition, the video and/or audio outputs can be supplied to an RF modulator to produce an RF output and/or 8 vestigal side band (VSB) suitable as an input signal to a conventional television tuner. This allows the receiver 1310 to operate with televisions without a video output.

In one embodiment, the decrypted packets transmitted from the transport module 1408 to the video decoder 1412 and/or audio decoder 1416 are transmitted via transport module using direct memory access (DMA) 1424 to the system RAM 1420. In other words, the transport module 1408 writes decrypted media program packets to the system RAM 1420 via DMA 1424, and reads those packets from the system RAM 1420 via DMA 1424 to provide them to the appropriate video decoder 1412 or audio 1416 decoder. The transport module 1408 may also include one or more secure internal memory modules that can be used to buffer media program packets, to store decryption information and/or instructions for performing the foregoing operations.

A description of the processes performed in the encoding and decoding of video streams, particularly with respect to MPEG and JPEG encoding/decoding, can be found in Chapter 8 of “Digital Television Fundamentals, by Michael Robin and Michel Poulin, McGraw-Hill, 1998, which is hereby incorporated by reference herein.

Controller 1410 receives and processes command signals from the user (e.g. from selecting controls on the receiver 1310 or an associated remote control. The main processor 1434 receives commands for performing its operations from a processor programming memory, which permanently stores such instructions for performing such commands. The processor programming memory may comprise a read only memory (ROM), an electrically erasable programmable read only memory (EEPROM) or, similar memory device. The main processor 1434 also controls the other digital devices of the receiver 1310.

The receiver 1310 may also comprise a local storage unit such as the video storage device 1422 for storing video and/or audio data obtained from the transport module 1408. Video storage device 1422 can be a hard disk drive, a read/writable compact disc of DVD, a solid-state RAM, or any other storage medium. In one embodiment of the present invention, the video storage device 1422 is a hard disk drive with specialized parallel read/write capability so that data may be read from the video storage device 1422 and written to the device 1422 at the same time. To accomplish this feat, additional buffer memory accessible by the video storage 1422 or its controller may be used. Optionally, a video storage processor can be used to manage the storage and retrieval of the video data from the video storage device 1422. The video storage processor may also comprise memory for buffering data passing into and out of the video storage device.

The functions implemented by the above-described modules may be implemented by a processor and memory resident in the module itself, or performed using a processor and/or memory of a communicatively coupled module. For example, in one embodiment, the transport module 1408 itself comprises a processor 1426 and a memory 1432 for performing the above described operations, including the identification of packets according to their identifiers and the decryption and distribution of data. Alternatively, some or all of those functions can be implemented using the controller 1410 processor executing instructions stored in memory 1436. Similarly, the video and audio decoders 1412, 1416 may include internal processors and memories for performing the functions described above.

The transport module 1408, video decoder 1412 and audio decoder 1416 may all be implemented on one or more integrated circuits. This design promotes both space and power efficiency, and increases the security of the functions performed within the transport module 1408. Further, the transport module 1408 alone or the transport module 1408 video decoder 1412 and audio decoder 1416 and their associated memories 1414, 1418 may be implemented on a single system on a chip (SOC) hereinafter referred to as a transport chip. This implementation inherently increases the security of the receiver 1310, and can be used to implement the watermarking functionality described further below.

### Watermarking Overview

Utilizing some of the secret and public data being programmed into a SOC chipset, readily identifiable data that cannot be controlled or manipulated by outside software is made available for purposes of inserting a watermark on reproduced media programs. The watermark data may be later recovered and compared to databases relating watermarks to receivers 1310 to forensically identify the receiver 1310 that reproduced the media program.

As described herein, the watermark generated from a receiver or secure processor unique identifier and is deterministically inserted piecemeal into a plurality of media program frames, with each portion of the watermark inserted into different portions of further or subsequent media program frames according to a receiver 1310 or secure data processor unique identifier. The transport chip includes a built-in function inside the video processing path that automatically places chip unique data into the outgoing video stream. Incorporating this process into the video processing process completely within the transport chip helps to assure the process is not compromised or circumvented.

The watermark portions may be inserted in every frame, or on a periodic basis. For example, a few bits of the watermark data could be placed in every N^{th} frame or given number of milliseconds (i.e. 750 ms) of the media program. This insertion rate would be below the level of detection threshold by the viewer, but still allow retrieval of the data for forensic applications. An algorithm that deterministically computes where the portions of the watermark are inserted within the media program (e.g. which portions of the frames in which order and/or which frames in which order) can differ for different secure data processor 1434 chip to chip, or vendor to vendor.

For example, one such low-overhead watermark placement algorithm is to divide the screen into 136 locations and cycle through each 4-bits of the receiver identifier to select one of these quadrants in which to place the watermark. Each new group of the 4-bits of the receiver identifier would define where the watermark is placed on the next interval. The algorithm for thus placing the watermark is straightforward, requiring almost no processing overhead in the receiver, is independent the video itself, and requires no processing by the headend. Occasionally the watermark may not be recoverable on post analysis but since it is always on the mark could be viewed at the next interval. Using this simple algorithm, portions of the watermark would jump around the screen as a function of the receiver identifier.

Other data could be included to help the forensic efforts, but care needs to be taken as to not create too complex a system as to increase chip overhead or potentially affect the quality of the video adversely.

The watermark-inserting functionality of the transport chip may be activated via a fuse in the transport chip 1408, via a suitable command. Once activated, the watermark function is always on and watermark data is thereafter always incorporated the data into the video stream. The command activating the fuse may include the manufacturer of the receiver 1310 or transport chip, the broadcaster 1302, or a third-party conditional access or digital rights management (DRM) vendor independent from the broadcaster 1302 or the receiver 1310 or transport chip vendors. In some instances, the fuse can be set via an over the air command, thus enabling turning the function on in the field after the receiver has been purchased and deployed to the subscriber station 1304. Since it is a fuse setting, there is no possibility of a hacker or unauthorized third party from turning this feature off once it is turned on.

Because the watermarking functionality is protected in software by a signed code region or a hardware-implemented function irreversibly incorporated into the transport chip video processing path, it is difficult or impossible to bypass by common techniques such as inserting software modules in unsigned code regions.

The watermarking technique described below does not require a software client at the headend 1302. Instead, the watermark insertion is performed by the receiver 1310 using a secure data processor 1434 executing software instructions that are protected from modification by boot protection that used an RSA signature protect a code region to ensure that the code cannot be modified in the field. Once enabled by the security fuse, the watermark insertion routine cannot be turned off by the receiver 1310.

This reduces the complexity and cost needed to incorporate watermarking into the media program distribution system 1300. It also eliminates a significant attack point for the pirates who may attempt to subvert or interfere with the watermarking process. For example, for some prior art systems, the watermark must be in a very specific area of the picture frame (like Video Blanking Interval Line 24) and nowhere else in the frame, or has to be in a blank frame that gets inserted into the video stream at the headend without disrupting the user experience. These restrictions do not apply with the system described herein, because the placement of the watermark is (deterministically) changed from frame to frame to stop someone from making a software tool that only searches in one spot to try to automatically remove the watermark. The watermark (or portions of it) can be placed anywhere in the uncompressed video frame, or as a part of the compressed data.

### Sample Embodiments

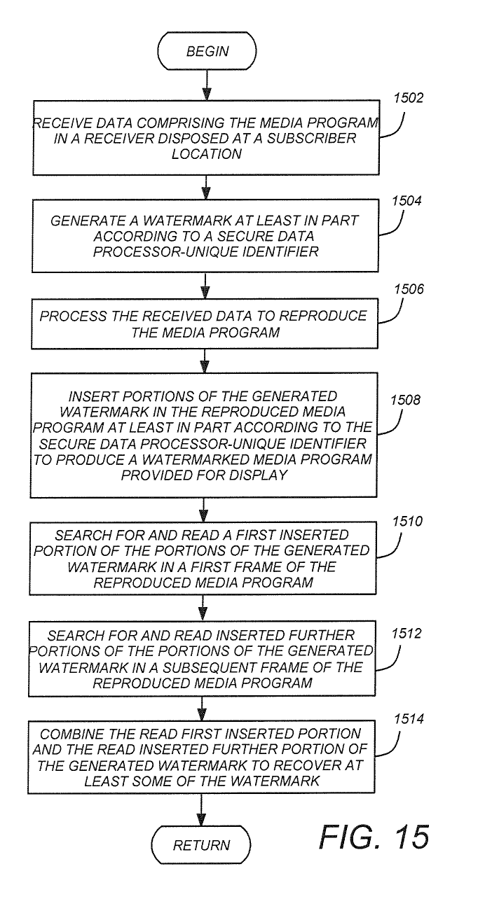

FIG. 15 is a diagram presenting an exemplary for inserting and recovering the watermark. In block 1502, data comprising a media program is received from a headend 1302 in a receiver 1310 at a subscriber station 1304. In one embodiment, the data is transmitted by satellite, terrestrial broadcast, or cable transmission, in which case, the transmission is received by the tuner/demodulator 1402 of the receiver, error corrected by the error correcting module 1404 and provided to a transport module 1408 disposed in a secure data processor 1434. In another embodiment, the media program is received via the Internet according to an Internet protocol (IP) paradigm.

In block 1504, a watermark is generated. In one embodiment, the watermark is generated at least in part according to unique identifier of a secure data processor 1434 of the receiver 1310, such as the product ID or PID

In one embodiment, the PID 1702 is stored in a secure memory 1436 in the secure data processor 1434. The PID may be stored during manufacture or before distribution to end users, for example by use of blackbox 116. The PID or an updated PID or other watermark parameters) may also be received for use in fielded CE devices. This can be accomplished, for example, using the techniques described above for securely transmitting data (D) to the receiver. In this case, the receiver PID(s) are transmitted or updated by the CE device receiving an encrypted customer global key E[CGK] and encrypted data ECGK[D], wherein the data (D) is encrypted according to the customer global key (CGK). The receiver then decrypts the encrypted customer global key E[CGK] to reproduce the customer global key and decrypts the encrypted data ECGK[D] with the reproduced customer global key to reproduce the data (D). The data (D) may then be securely stored in the secure memory of the secure data processor. The data (D) may include the secure data processor-unique identifier (PID) and/or CE device software, including Whitebox software.

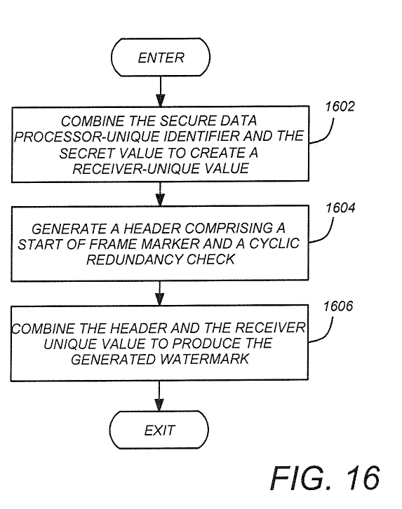

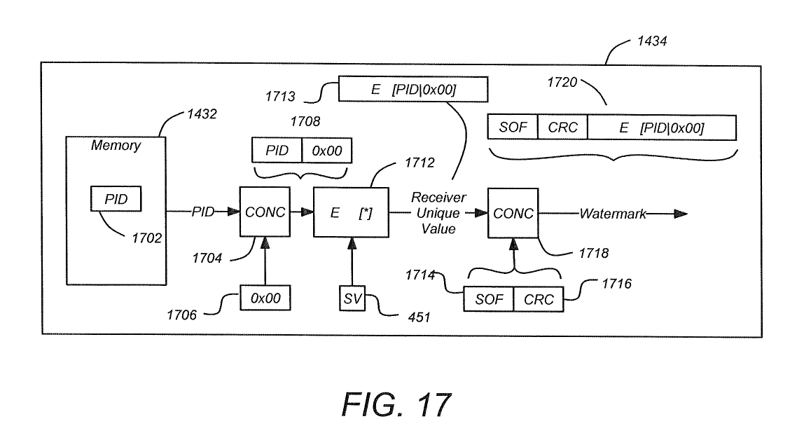

FIGS. 16 and 17 are a diagram illustrating one embodiment of how the watermark may be generated. In block 1602 of FIG. 16, the PID 1702 (in one embodiment, analogous to PID 600 of FIG. 6) is used to create a value that is unique to the receiver 1310. In one embodiment, the PID 1702 is combined with a secret value (SV) to create a receiver unique value 1713. This combination can be a simple concatenation of the PID and the SV, an exclusive OR operation applied to the PID and the SV, or the PID may be encrypted with the SV, for example, using encryptor 1712, or any combination of the foregoing.

FIG. 17 presents a diagram illustrating an embodiment in which the PID 1702 retrieved from a secure memory 1436 in the secure data processor 1434. The PID 1702 is concatenated with another value (in the illustrated embodiment (0x00) of block 1706 by a concatenation process 1704 implemented by the secure processor 1434 to generate value 1708. This value 1708 then encrypted with a value such as secret value SV 451 to generate a receiver-unique value 1713.

Returning to FIG. 16, in block 1604, a header is generated comprising a start of frame marker (SOF) 1714 and a cyclic redundancy check (CRC) 1716. The SOF 1714 marker identifies the point in a frame where the first portion of the watermark will be inserted, as discussed further below.

The CRC 1716 is an error-detecting code that detects changes to the watermark and is later used to determine if the entire watermark has been regenerated or recovered. The CRC 1716 is computed based on the watermark data (for example using polynomial division, XORing or a summing), and added to the watermark (for example, by creating a header of the SOF 1714 concatenated with the CRC 1716). Upon retrieval of the portions of the watermark inserted into different portions of succeeding frames, the computation of the CRC based on the currently retrieved or recovered watermark portions and compared to the CRC 1716 in the header. If the computed CRC and the CRC 1716 read from the header do not match, the system searches for further watermark portions and/or reject some data originally thought to be part of the watermark.

Next, as shown in block 1606, the header and the receiver unique value 1713 are combined to produce the generated watermark 1720. This may be accomplished via the concatenation operation 1718 shown in FIG. 17.

The beginning of the watermark 1720 can be identified by the SOF 1714. Since a deterministic byte stuffing technique is used as is commonly done in data communication protocols, the actual length of the watermark 1720 may be variable. Optionally the SOF 1714 can be followed by an explicit length parameter to provide a fixed length for the embedded watermark 1720 that includes the header.

Returning to FIG. 15, the received data is processed to reproduce the media program, as shown in block 1506. Typically, the received data is transmitted in a packetized transport stream having a plurality of media programs, with each packet associated with a channel or program identifier. The transport module identifies the packets associated with the desired media program or channel and provides those packets to the video decoder 1412 and audio decoder 1416 for further processing to recover the video and audio information for display. Typically, the media program is represented by a plurality of frames that are sequentially produced to the viewer. In the MPEG standard, these frames include I-frames, B-frames, and P-frames. I-frames are intra-coded key or anchor frames that include all of the information necessary to decode and decompress the information in the frame. I-frames are analogous to a conventional static image. P-frames are predictive frames that represent the changes in the image when compared to the previous frame. B-frames are bi-predictive, meaning that they use differences between the current frame and the following frame to specify content. MPEG decoders take the information in the I, P, and B frames and combine them to create a series of video frames that reproduce the media program when presented sequentially. Before providing those video frames for further processing by the video processor 1428 (if necessary), the video decoder places those frames in a frame memory or buffer 1414. Similarly, the audio decoder 1416 may place data in a buffer or memory 1418.

Next, portions of the generated watermark are inserted in the media program as shown in block 1508. In one embodiment, this is performed so that the frame and the portion of the frame that the watermark or portion of a watermark is inserted is deterministic in a way that identifies the receiver 1310 that has inserted the watermark. In a preferred embodiment, the portions of the watermark are inserted at least in part according to a combination of the PID 1702 and SV 451. For example, a first portion of the watermark may be inserted in to a first portion of a first frame of the media program and a further portion of the watermark may be inserted into a temporally subsequent frame at a location (for example, spatial location) within that second frame as determined by the PID 1702/SV 451 combination. The temporally subsequent frame may be the frame that immediately follows the first frame (so that there are no frames without a portion of the watermark), or the next watermark portion may be inserted into a temporally subsequent frame that is N frames later. Further, other embodiments are possible in which the location of each of the watermark portions is determined by the PID 1702 instead of a combination of the PID 1702 and the SV 451.

The PID 1702 or PID 1702/SV 451 can be used to deterministically and uniquely place portions of the watermark in other ways as well. For example, the PID 1702 and/or SV 451 may determine which subsequent frame the second portion of the watermark is inserted, but not the location within that subsequent frame. Or, the PID 1702 and/or SV 451 may determine both the subsequent frame into which the second watermark portion is inserted and the location within that subsequent frame (e.g. which frame portion the second watermark portion is inserted into). The PID 1702 and/or SV 451 can also be used to determine how large a portion of the watermark is inserted into each frame. For example, the number of bytes inserted into each subsequent frame may be determined according to the PID 1702 and/or SV 451.

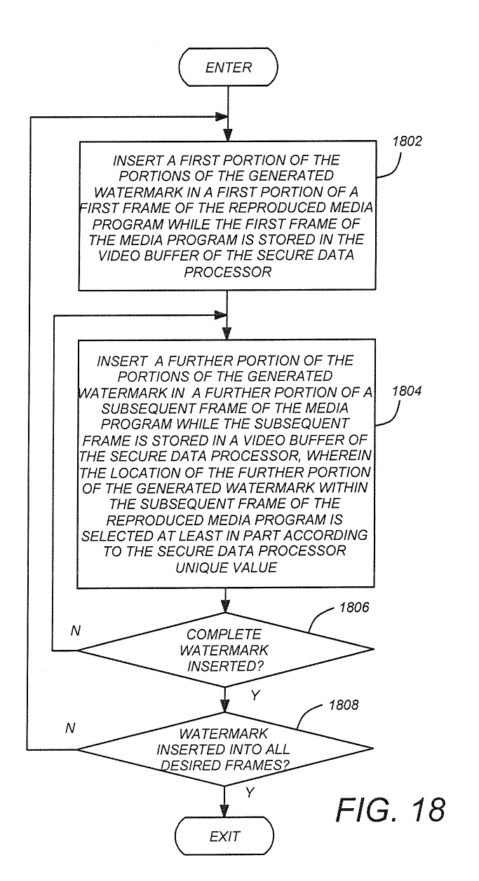

FIG. 18 is a diagram illustrating exemplary method steps that can be used to insert the watermark into the frame(s). In this embodiment, the watermark is divided into a plurality of portions, and each of these watermark portions are inserted into a portion of the frames as determined by the PID 1702/SV 451. Turning first to block 1802, a first portion of the portions of the watermark are inserted into a first frame of the reproduce media program.

In block 1804, a further portion of the portions of the generated watermark are inserted into a further portion of a subsequent frame of the media program while that subsequent frame is stored in a video buffer of the secure data processor 1434. The location that the further portion of the generated watermark is stored is selected at least in part according to in the secure data processor 1434 unique value (e.g. the PID or PID/SV combination). In block 1806 a determination is made regarding whether the complete generated watermark has been inserted into the media program. If not, processing returns to block 1804 where a still further portion of the portions of the generated watermark is inserted in a further subsequent frame of the media program, again at a location (a further subsequent frame portion) determined at least in part according to the secure data processor 1434 unique value.

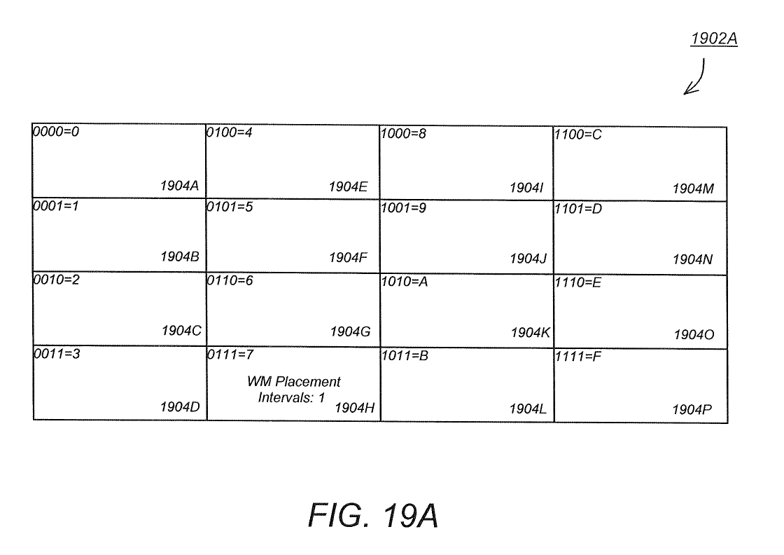

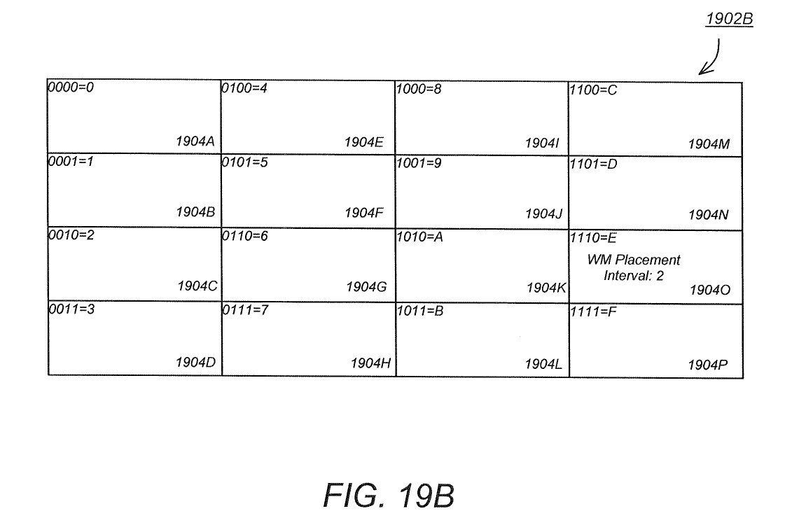

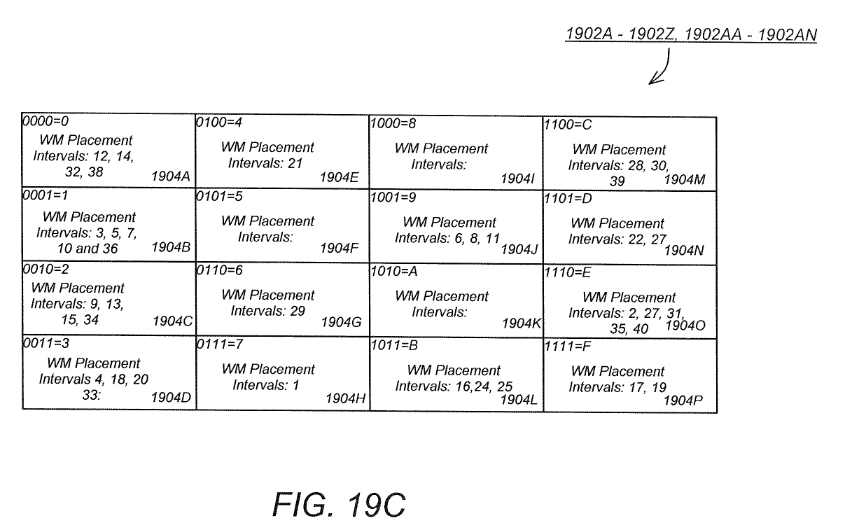

FIGS. 19A-19C are diagrams showing a particular example of the generation of a watermark and its insertion into multiple frames of the media program. In this example, we assume transport chip 1434 has:
Secure data processor identifier (PID)=E56BFD29036FD4D0 (ASCII HEX); and
Secret value (SV) of 790297C19B937E348F3754EE471262BE (ASCII HEX)

Using the operations described above with respect to FIGS. 16 and 17, the watermark may be generated by concatenating the PID 8 zeros to form a 16-byte block:
E56BFD29036FD4D00000000000000000 (plaintextBuffer)

That concatenated PID may be processed (e.g. decrypted via the advanced encryption standard, AES) using the secret value (SV), resulting in:
AES-D(SV, plaintextBuffer) 2190202BF3F34DABBAEC6CE032E1D0CE (ciphertextBuffer)

Next, a CRC can be computed over the result of the above AES operation:
CRC16(ciphertextBuffer)=1919

And the watermark can be created by concatenating a SOF value with the CRC, wherein the SOF value=2 byte start of frame (7E+length). This results in the following watermark:
7E1319192190202BF3F34DABBAEC6CE032E1D0CE

Portions (or “nibbles”) of the watermark can then be placed in the appropriate section of a series of media program frames, based on each portion of the watermark that is inserted.

FIG. 19A is a diagram of a first frame 1902A of the reproduced media program. The first frame 1902A comprises a plurality of frame portions 1904A-1904P, each associated with an ASCII value 0-F. In the example, the first portion of the watermark is the character “7” and so the first “nibble” of the watermark data is stored in the portion of the media program frame associated with the character “7.” The data that is actually inserted into portion 1904H may be binary data equal to the value of the portion of the watermark (e.g. 0111), may be a character or symbol (e.g. ♦ or *), which may or may not be mapped to the watermark value (e.g. ♦=7). This is preferably accomplished while the media program frame 1904A is stored in the uncompressed video buffer of the secure data processor 1434. Inserting the most significant portion of the watermark (which constitute the header, which has the SOF 1714 and CRC 1716) permit the beginning of the watermark to be more easily found in subsequent processing, as further described below.

### Watermark Domains

The watermark data can be inserted into the frame portion using a variety of techniques. Such techniques add or modify values representing data in the time domain, frequency domain, a wavelet series, discrete cosine coefficients. Such data may comprise component data such as Y (luma), U (blue chrominance), or V (red chrominance) data in the YUV (or YCbCr) frame color coding format or additive red-green-blue (RGB) color coding format.

For example, watermark portions may be substituted for the bits (such as the least significant bits) of one or more of the colors, causing the hue of that portion of the frame to differ slightly from the original value. Further, the modified values may be value representations in the time domain, frequency domain (e.g. fast Fourier), or wavelet series coefficients. Embedding watermarks in the frequency domain offers increased robustness against noise and geometric transformations. Modification of compressed elements such macroblocks and motion vectors allows the elements to be modified before decoding to increase speed and provide for work around access limits after decoding.

This can be accomplished in either the YUV or RGB color models, with modification of the appropriate coefficients. In embodiments using a color lookup table (CLUT) defining the palette of colors, the indexed color can be altered. Further the bit substitutions or modifications can be performed on compressed or uncompressed data. For example, watermark data may be substituted for the least significant bits of luminance (luma macroblocks in MPEG or luma coding tree units in HEVC), chrominance (chroma macroblocks in MPE of chroma coding tree units of HEVC), hue, intensity, motion vector, interframe prediction or timing data of the portion of the media program frame, as described in U.S. Pat. No. 9,271,016, hereby incorporated by referenced herein. Further, the watermark portion may be blended into the color scheme of the background image by using a constant color and an XOR operation with the underlying bits. In one embodiment, each watermark portion occupies no more than approximately 2% of each of the media program frame portions 1904 shown in FIGS. 19A-19C. Determining where and how watermarks are inserted can be determined, for example, according to an estimated perceptual characteristic of the reproduced media program, in order to minimize apparent effect of watermarking to the viewer.

FIG. 19B is a diagram of a subsequent frame 1902B of the reproduced media program. In the example, the next portion of the watermark is the character “E”, so the second portion of the watermark would be placed in the portion of the subsequent media program frame 1902B that is associated with the character “E”, or portion 19040. Again, the data that is actually inserted may be binary data equal to the value of the portion of the watermark (1110) or may be a character or symbol.

As shown in block 1806 of FIG. 18, these operations continue until the complete watermark (in this case, 40 portions, designated as A-AN) has been inserted into subsequent frames of the media program. The result is that the watermark portions are inserted into the initial frame and subsequent frames as shown in FIG. 19C in frames 1902A-1902AN. After this has been accomplished, block 1808 routes processing back to block 1802 so the watermark is again inserted into the media program frames as described in blocks 1802 and 1804. In the foregoing example, 4 bits of a 20-byte watermark is placed into the decompressed media program frames, while those frames reside in the video buffer 1414. The entire watermark can be placed in 40 successive 4-bit placements. If desired, watermark portion placement can be attempted in only even or odd frames, and these frames may be consecutive or spaced apart by frames without watermark data.

In the foregoing example, the mapping of watermark 1720 portions to frame portions 1904 remained constant during the insertion of the watermark 1720 portions in the media program frames 1902. In other embodiments, this mapping is changed so that the start of frame marker for the next inserted watermark does not necessarily fall in the same portion of the media program frame. For example, after the first watermark is completely inserted into the media program frame 1902, the zero (0000) frame portion 1904A may be moved to the location formerly occupied by the three (0011) frame portion 1904D. Other frame portions may then be mapped based upon the new position of the zero (0000) frame portion. For example, frame portions zero, one, and two may be placed in locations 1904H, 1904I and 1904J, with the remainder of the frame portions following the same pattern. The choice of where the zero frame is rotated can be deterministic and also based on the PID 1702 or a combination of the PID 1702 and the SV 451. In one embodiment, the location to which the of the following zero frame may be a function of the last byte in the watermark. For example, in the illustrated example, the last two byte in the watermark was the characters “C” and “E” and this information can be used to define the rotation of the zero portion by an amount equal to the sum or other combination of “C” and “E.” Other paradigms in which the rotation of the zero frame is random are also possible. Further, the secret value SV 451 may be programmed into the CE device 112 using black box 116, without use of the black box 116, or generated by the CE device 112 or the SOC 114, as described publication WO2017117574, which is hereby incorporated by reference herein.

It is important to note that the watermark insertion paradigm illustrated in FIGS. 19A-19C does not impose any watermark timing considerations in the video processing performed by the receiver 1310. In other words, if the video processing does not allow enough time to insert the next succeeding watermark portion in the designated portion 1904 of the desired media program frame, that operation may be delayed to the same designated portion 1904 of the following media program frame or even the frame after, because it is the pattern by which the data is inserted that allows recovery of the watermark.

The foregoing operations are performed using instructions permanently and unchangeably coded into the secure data processor 1434 by its manufacturer. These instructions may be integrated with other routines performed by the secure data processor 1434 and are typically stored in a code region protected by an RSA signature to prevent modification by an attacker.

Returning to FIG. 15, once inserted into the media program, the watermark provides the ability to forensically identify the receiver 1310 that reproduced the media program. This can be accomplished by searching for and reading the first inserted portion of the watermark of in the first frame of the reproduced media program, as shown in block 1510. Next, block 1512 searches for and reads the inserted further portions of the watermark in a subsequent frame 1902B of the media program at a location within the subsequent frame 1902B. Then, the watermark is regenerated by combining the read first inserted portion and the read further portion(s) of the watermark, as shown in block 1514. The PID of the secure data processor 1434 can then be compared to the recovered watermark and used to identify the receiver 1310 that reproduced the media program as further described below.

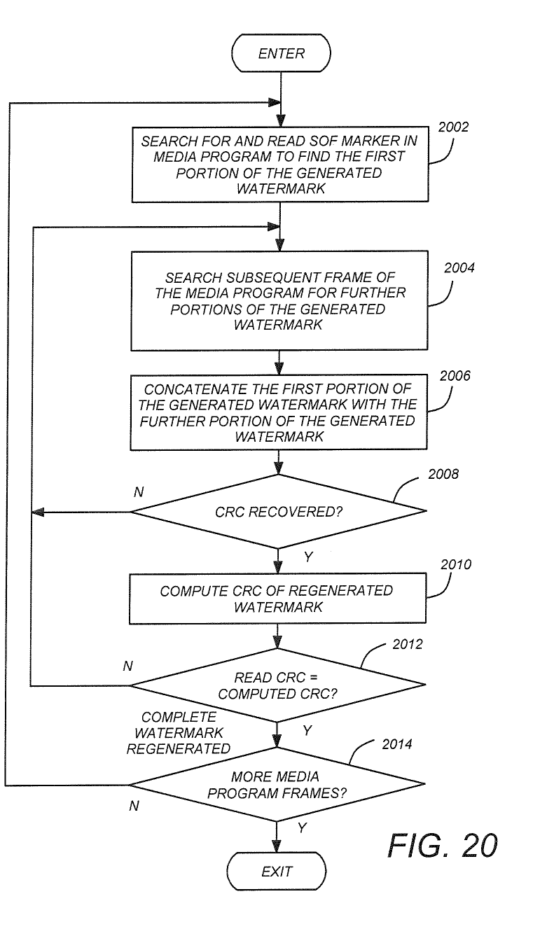

FIG. 20 is a diagram illustrating exemplary method steps that can be used to recover the watermark. In block 2002, a first frame 1902A of the media program is searched to find the SOF marker 1714. This can be accomplished with algorithms that perform analysis of the frames of the media program (which may be isolated via a screen capture function) to identify frame portions that have been modified from their original state. For example, edge detection algorithms can be employed to determine candidate frame portions 1904 where watermark data may have been inserted. Returning to the example shown in FIGS. 19A-19C, the SOF marker “7” is stored in portion 1904H of media frame 1902A.

As shown in block 2006, a subsequent frame 1902B of the media program (which may be temporally adjacent subsequent frame or a frame N frames distant) is searched to find a further portion of the watermark, again by performing an analysis of the image, for example, using edge detection algorithms. In block 2006, the read first portion of the watermark and read further portion of the watermark are concatenated to begin reconstruction of the watermark. This continues until the CRC has been recovered, as shown in block 2008. Returning to the example shown in FIGS. 19A-19C, the CRC of 1919 is stored in intervals 5-8, or in media frame portion 1904B of the 5th media program frame 1902E, frame portion 1904J of the 6th media program frame 1902F, in media frame portion 1904B of the 7th media program frame 1902F, and in media frame portion 1904J of the 8th media program frame 1902G. Therefore, block 2008 directs processing to block 2004 until the entire CRC has been recovered.

In block 2010, a CRC is computed for the currently reconstructed watermark, and block 2012 compares the CRC of the currently reconstructed watermark with the CRC recovered after block 2008. If the two CRCs match, the complete and accurate watermark has been regenerated, and processing is passed to block 2014. If the read CRC does not match the computed CRC, this indicates that not all portions of the watermark have been recovered, and processing returns to block 2006. In the illustrated example, there is no computed CRC for the watermark (as only the SOF and the CRC fields have been recovered), so block 2012 passes processing to block 2004 and a subsequent frame is again searched for further portions of the watermark. In the illustrated example, the first byte of the watermark to follow the SOF and the CRC is “2,” which is stored in media frame 1902H at media frame portion 1904C. Block 2006 concatenates this data with the portions already recovered and passes processing to block 2008. Since the CRC has already been recovered, block 2008 passes processing to block 2010, where the value “2” is used to compute the CRC of the recovered watermark. Since this single value will not result in a computed CRC that matches the recovered value of (1919), block 2012 reroutes processing to block 2004 where same operations are performed. This process continues until block 2012 determines that the read CRC and the computed CRC match, at which time, the complete watermark has been recovered.

Once the entire watermark has been recovered, processing is passed to block 2014, which returns processing to block 2002 to begin the watermark recovery process anew for additional subsequent media program frames and ends processing if there are no further media program frames to analyze. Confidence in reconstructing the correct watermark is achieved by computing the CRC16 function over the recovered watermark. However, the process may continue, with further watermarks being recovered. Since all of the watermarks should be from the same receiver having the same secure processor ID (and also the same receiver ID), errors in the watermark recovery can be reduced by post processing the retrieved watermarks to eliminate spurious results. For example, if 95% of the recovered watermarks are identical, it can be reasonably assumed that the remaining 5% of the watermarks were recovered in error.

In the foregoing embodiment, the watermark information is held at least in part by the location of the portion of the media program frame in which the inserted symbols or data are found. However, the data stored in those portions of the media program frames can also be used as the watermark or to assist in the recovery of the watermark. For example, each receiver 1310 may be configured with an at least partially unique mapping between the watermark portions and the symbols that are written in the media frame portions (for example, a particular receiver may be configured to write a particular symbol (e.g. ♦ when the watermark portion is a “7”). In this embodiment each position could be mapped to a unique symbol and that information can be used in the recovery process to eliminate errors in recovering the watermark or in confirming the recovery of the watermark.

### Further Embodiments

In the above embodiments, watermark insertion is performed by the CE device 112 such as the receiver 1310 using a secure data processor 1434 executing software instructions that are protected from modification by boot protection that used an RSA signature protect a code region to ensure that the code cannot be modified in the field. In another embodiment, the insertion of the watermark is assured by preventing any disabling of the module implementing the watermark generation and/or insertion processes. This can be accomplished, for example, as described in U.S. Patent Publication US20170302446, in which decryption of content requires both a key base and at least one key contribution. The key base is provided to a decryptor, but the decryptor is incapable of decrypting the content until the key contribution is provided by a control module or application. The control module can be configured to only provide the key contribution when watermark operations are enabled.

The insertion of the watermark can be accomplished using private tokens, thus enabling the anonymous tracking of digital content and permitting remediation of unauthorized distribution. Such techniques are described in PCT Publication WO2017117574A1, which is hereby incorporated by reference herein. Further, the same modification may be applied to the data in all frames of a media program.

### Whitebox Implementations

The encryption of information before dissemination protects communication channels from eavesdropping. Typically, the endpoints of the communication channels (e.g. the transmitter and the receiver) are assumed to be trusted such that attackers have access only to input data and output data, with operations performed within either of the endpoints being invisible to users or potential hackers. For this model to comply, cryptographic processing must take place in a secure environment such as a Trusted Execution Environment (TEE). However, cryptanalysis techniques now include the use of side-channel information that can be observed during the execution of crypto algorithms, such as execution timing, electromagnetic radiation, and power consumption. Such techniques make it difficult for any device to be a “black box,” and in fact, render the devices a “grey box” devices. It is difficult to mitigate such side channel attacks, as observables are difficult to decorrelate from operations on secret keys, and because of form factor and performance requirements on the processing elements performing the cryptographic operations.

Attack models that assume that the endpoint devices are “open” and all operations are completely observable and alterable by the attackers (such as PCs, tablets, smartphones that do not have secure elements), and they also have full control over the execution platform (memory registers, CPU calls, etc.). Whitebox cryptography addresses these issues, permitting a cryptographic algorithm to be implemented in software in such a way that the cryptographic assets such as keys remain secure even when subject to Whitebox attacks. Software implementations that resist such white-box attacks are known as white-box implementations. Whitebox implementations are effective in applications were a cryptographic key is involved to protect assets, for example in DRM applications.

Whitebox techniques transform a cipher into a series of key-dependent lookup tables. The secret key is hard-coded into the lookup tables and protected by applied randomization techniques. One such method injects random annihilating encodings which are merged together with the lookup tables such that the lookup tables and the dataflow between table lookups is randomized, while retaining the overall semantic functionality of the implementation.

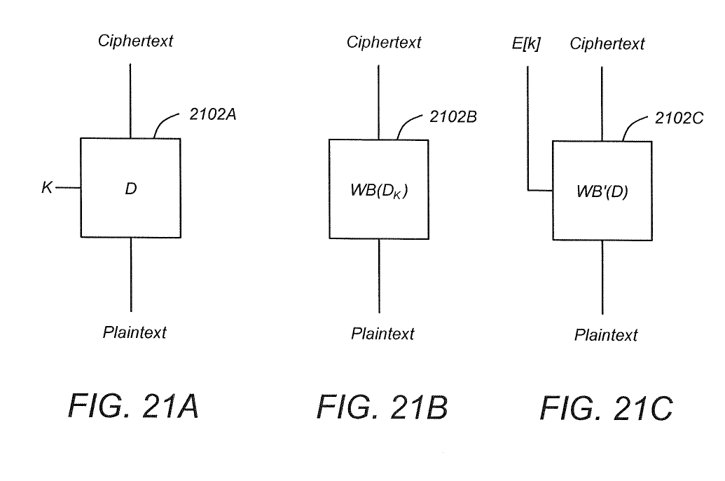

Whitebox implementations may include fixed key or dynamic key embodiments. FIGS. 21A-21C are diagrams illustrating a comparison with a blackbox implementation of a decryptor and fixed and dynamic key Whitebox embodiments of the decryptor.

FIG. 21A is a diagram illustrating a blackbox decryptor 2102A that accepts ciphertext and decrypts the ciphertext using a key (k) supplied to the decryptor. As described above, the security of such an implementation relies upon the unobservability of the decryption process itself, which cannot be assured. FIG. 21B is a diagram illustrating a Whitebox decryptor 2102B that uses a fixed key (e.g. the secret key is hard coded in the Whitebox implementation). FIG. 21C is a diagram illustrating a dynamic key Whitebox decryptor 2102C. Dynamic white box implementations are instantiated with a key k only at the time they are called. In this case, the original key (k) is not presented, as that would lead to an easy disclosure. Instead, a protected (e.g. encrypted) version of the key E[k] is used. The dynamic white-box implementation then performs an encryption/decryption operation, by parsing the protected version of the key in such a way that no information about the key is exposed.

Hence it is desirable in certain instances, such as resource constrained environments, to utilize obfuscated software to hide both key and algorithm for certain cryptographic transactions. Described below is a model that uses a Whitebox that that takes an encrypted key and ciphertext input data to produce plaintext output. The Whitebox uses a static key to decrypt the encrypted key for use in the cryptographic processing of the ciphertext.

The Whitebox is generated using a tunable library that allows for the code/data expansion required for the security needs of the application. The library generates entropy for each run for uniqueness between each generated Whitebox.

The uniqueness guarantees that each desired instance of the use of this process results in a different key that can be used in the end application as discussed in this disclosure for the CGK, PPK and SV values as desired. In this case, the unique key or common key (if the same output value is used in many deployed clients) can be downloaded after the device has entered the field, replaced by a new instance in the event of a compromise, or loaded during manufacturing. Thus, OTP memory is not required.

The Whitebox application can be used in STBs, secure CPUs, SmartTVs or any unsecure device such as an automotive controller or Raspberry Pi controller. This downloaded application can transform any inherently unsecure device into a secure device by installing a root of trust key in the device receiving the Whitebox application. The root of trust key can used in a number of cryptographic operations such as AES, DES, or Triple DES calculations. A second or third root of trust key can be installed by downloading a second or third instance of a Whitebox application each creating its own root of trust key. The entire downloaded application can be further obfuscated both at the source code and/or binary level using standard software obfuscation tools from Stunnix Obfuscator, Cloakware or Inside Secure.

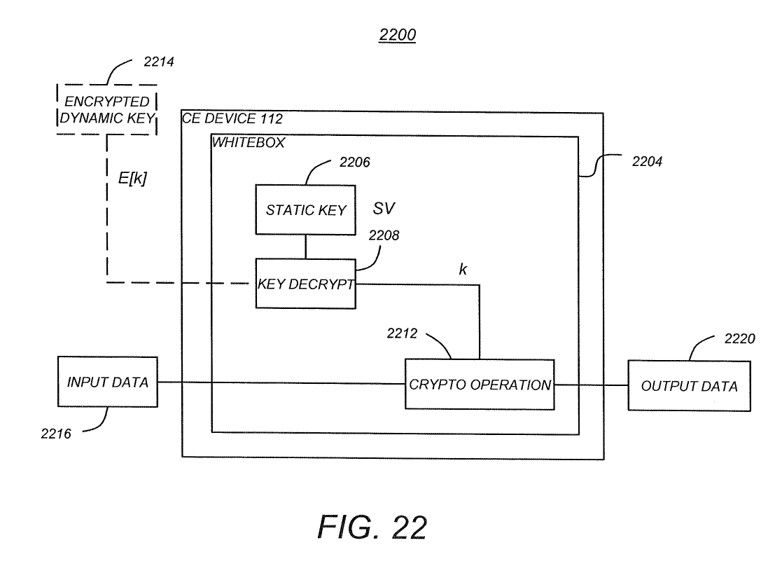

FIG. 22 is a diagram illustrating an exemplary Whitebox implementation 2200. In this embodiment, the CE device 112 has a Whitebox implementation (e.g. software executed by a processor) that accepts ciphertext input data (for example, an encrypted media program or other data) and generates output data 2220 (for example, a decrypted media program) using an encrypted dynamic key 2214. In the illustrated embodiment, the Whitebox 2104 implements the obfuscated static key 2206, a key decryption algorithm 2208 element, and the crypto function or operation 2212. The key decryption element 2208 of the Whitebox 2204 accepts and decrypts the encrypted dynamic key E[k] 2214 to produce the (unencrypted) dynamic key k, which is provided to the crypto element 2212 of the Whitebox 2204. Input data 2216 is provided to the crypto element 2212 and decrypted using the dynamic key k to produce the output data 2220. Note that FIG. 22 presents a functional representation of the operation of the Whitebox 2104 and illustrates generating the output data 2220 from the input data 2216 and the encrypted dynamic key E[k]. The actual computations performed within the Whitebox 2204 may not mimic the representation shown in FIG. 22. For example, while the key decrypt element 2208 generates the dynamic key and the crypto operation 2212 uses this key to generate the output data 2220 from the input data 2216, these operations may be accomplished as a single functional mapping, for example, using look up tables.

The foregoing operations can be used to generate, for example the secret value such as SV 451 that would otherwise be programmed into the SOC 114 using the black box. For example, if a particular CE device 112 has been compromised, the service provider 102 or security provider 106 may simply download a new software image to the CE device 112. This software image may include a Whitebox implementation of the cryptographic function needed to generate other cryptographic parameters. In that case, the static key 2206 functions essentially like the SV 451, and can be used to derive other keys as needed.

In situations (such as described above with respect to the generation of the CGK and the PPK from the SV 451), a key ladder may be implemented, generating number of keys from a root key such as SV 451. Such embodiments require the use of multiple Whitebox implementations in the CE device 112.

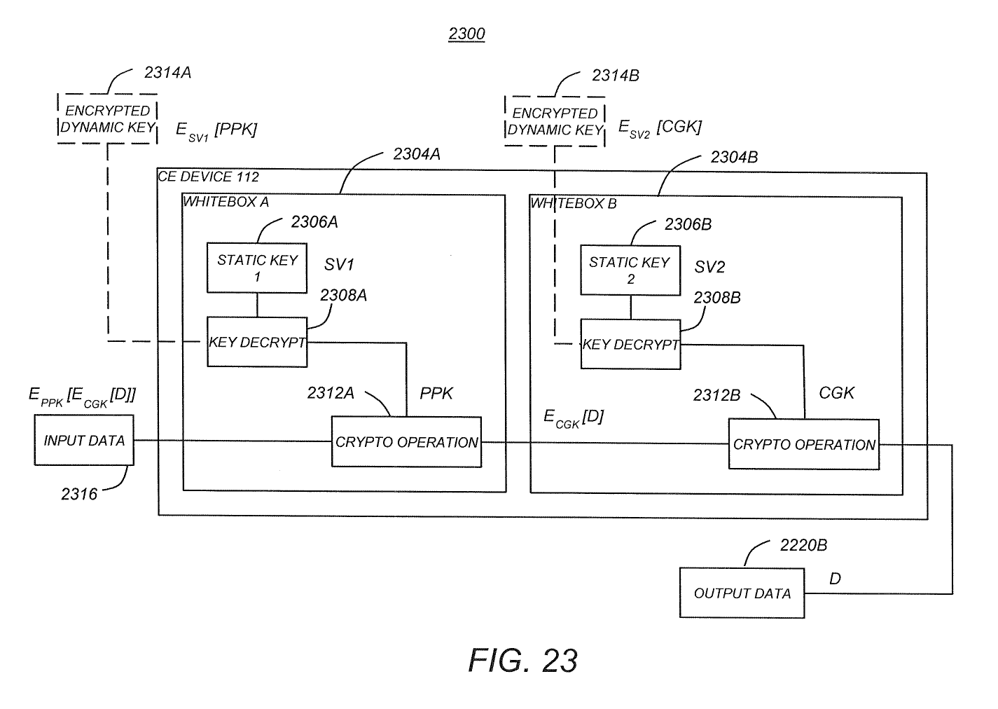

FIG. 23 is a diagram illustrating a CE device 112 having a first Whitebox implementation (Whitebox A 2304A) and a second Whitebox implementation (Whitebox B 2304B). In this embodiment, the first Whitebox implementation 2304A includes a first static key 2306A, for example, a first secret value SV1 451. The second Whitebox implementation 2304B includes an inherent second static key 2306B, for example, a second secret value SV2 451.

In this embodiment, data, such as a key required to decrypt a media program or a software upload, is encrypted according to the CGK, and then encrypted by the product provisioning key PPK, thus resulting in E_{PPK}[E_{CGK}[D]]. This input is provided to the CE Device 112 for decryption to recover the data. An encrypted dynamic key (in this case the PPK encrypted by the first static key (first secret value SV1) is provided to Whitebox A 2304A (e.g. by service provider 102 or security provider 106), which decrypts the encrypted dynamic key using decryptor element 2308A to produce the unencrypted dynamic key PPK. The unencrypted dynamic key PPK is used by crypto operation 2312A to decrypt the doubly encrypted input data E_{PPK}[E_{CGK}[D]] to produce encrypted data E_{CGK}[D]. This encrypted data E_{CGK}[D] is provided to the Whitebox B 2304B. A second encrypted dynamic key E_{SV2}[CGK] is provided (e.g. from service provider 102 or security provider 106). Whitebox B decrypts the encrypted dynamic key 2314B with key decrypt element 2308B to recover the CGK. The CGK is then supplied to crypto operation 2312B to decrypt encrypted data E_{CGK}[D] provided by Whitebox A 2304A to produce the output data 2220B.

Note that if the CE device 112 is compromised, an updated version of either one of the Whiteboxes 2304 may be uploaded and installed on the CE Device 112. For example, if the PPK is compromised, a new version of Whitebox A 2304A may be uploaded, with a different value for static key SV1 and/or different crypto operation 2312A. Or, if the CGK is compromised, a new version of Whitebox B 2304B may be uploaded, with a different value for static key SV2 and or different crypto operation 2312B. Or in either case, new versions of both Whitebox A 2304A and Whitebox B 2304B can be downloaded. Also note that either or both Whiteboxes may be a fixed key implementation instead of a dynamic key implementation.

Whiteboxing techniques can also be used to verify, prove or attest to the fact that a genuine SOC 114 is running on the CE device 112 rather than a clone or emulator. For example, a global key may be programmed into the OTP 152B of the SOC 114 (with or without a black box 116). As a part of a power-up, boot, or other functional process, the global key can be provided to a Whitebox 2012, as a ciphertext input and the output compared to a reference or expected value (for example, obtained from the service provider 102 or the security provider 106) to verify that a genuine SOC 114 is being used with the CE device 112. If comparison indicates that the SOC 114 is not genuine, the associated process is terminated.

Further, to prove that the value was obtained using the proper code a SOC 114 identifier, PID 1702, or model ID can also be provided as an input to the Whitebox (e.g. a dynamic key Whitebox 2012C implementation), with the output of the Whitebox 2102C compared to a different expected value. This allows verification that the CE device 112 is using the proper SOC 114 and CE device 112 code (the rather than a simulator of the CE device 112 code), since the Whitebox 2102C is integrated with the CE device code. Again, if comparison indicates that the SOC 114 or the improper Whitebox 2102C is used is not genuine, the associated process is terminated.

Further, a user and/or content unique application could be used to implement one or more of the operations illustrated in FIG. 17 used to generate a user and/or content watermark or the operations used to place the generated watermark in the media program in a way unique to the user and/or content.

### Hardware Environment

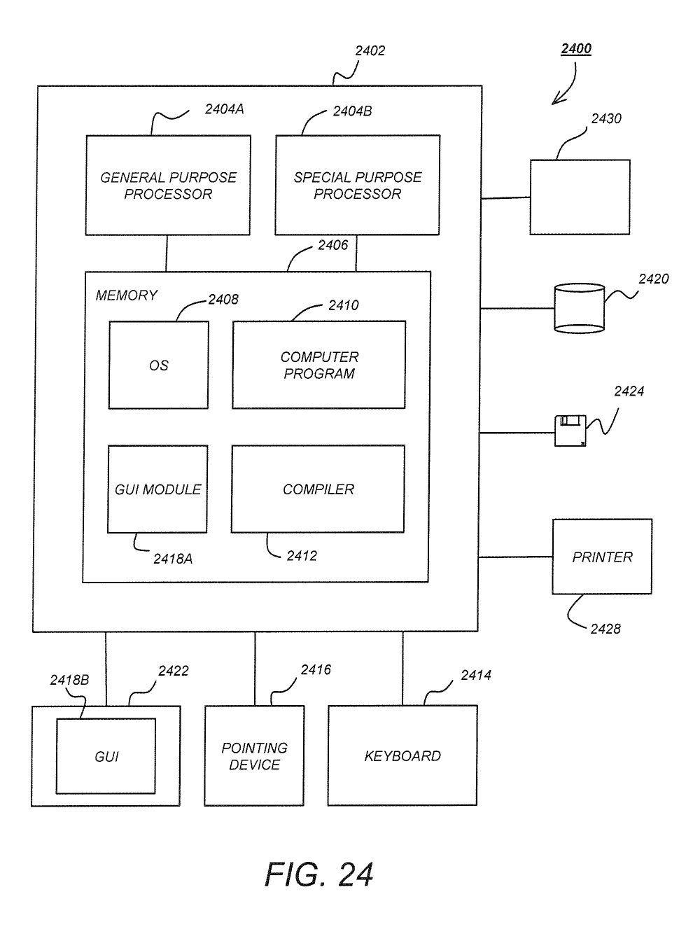

FIG. 24 is a diagram illustrating an exemplary computer system 2400 that could be used to implement elements of the present invention. The computer 2402 comprises a general-purpose hardware processor 2404A and/or a special purpose hardware processor 2404B (hereinafter alternatively collectively referred to as processor 2404) and a memory 2406, such as random-access memory (RAM). The computer 2402 may be coupled to other devices, including input/output (I/O) devices such as a keyboard 2414, a mouse device 2416 and a printer 2428.

In one embodiment, the computer 2402 operates by the general-purpose processor 2404A performing instructions defined by the computer program 2410 under control of an operating system 2408. The computer program 2410 and/or the operating system 2408 may be stored in the memory 2406 and may interface with the user and/or other devices to accept input and commands and, based on such input and commands and the instructions defined by the computer program 2410 and operating system 2408 to provide output and results.

Output/results may be presented on the display 2422 or provided to another device for presentation or further processing or action. In one embodiment, the display 2422 comprises a liquid crystal display (LCD) having a plurality of separately addressable pixels formed by liquid crystals. Each pixel of the display 2422 changes to an opaque or translucent state to form a part of the image on the display in response to the data or information generated by the processor 2404 from the application of the instructions of the computer program 2410 and/or operating system 2408 to the input and commands. Other display 2422 types also include picture elements that change state in order to create the image presented on the display 2422. The image may be provided through a graphical user interface (GUI) module 2418A. Although the GUI module 2418A is depicted as a separate module, the instructions performing the GUI 2418B functions can be resident or distributed in the operating system 2408, the computer program 2410, or implemented with special purpose memory and processors.

Some or all of the operations performed by the computer 2402 according to the computer program 2410 instructions may be implemented in a special purpose processor 2404B. In this embodiment, some or all of the computer program 2410 instructions may be implemented via firmware instructions stored in a read only memory (ROM), a programmable read only memory (PROM) or flash memory within the special purpose processor 2404B or in memory 2406. The special purpose processor 2404B may also be hardwired through circuit design to perform some or all of the operations to implement the present invention. Further, the special purpose processor 2404B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 2402 may also implement a compiler 2412 which allows an application program 2410 written in a programming language such as COBOL, C++, FORTRAN, or other language to be translated into processor 2404 readable code. After completion, the application or computer program 2410 accesses and manipulates data accepted from I/O devices and stored in the memory 2406 of the computer 2402 using the relationships and logic that was generated using the compiler 2412.

The computer 2402 also optionally comprises an external communication device such as a modem, satellite link, Ethernet card, or other device for accepting input from and providing output to other computers.

In one embodiment, instructions implementing the operating system 2408, the computer program 2410, and/or the compiler 2412 are tangibly embodied in a computer-readable medium, e.g., data storage device 2420, which could include one or more fixed or removable data storage devices, such as a zip drive, floppy disc drive 2424, hard drive, CD-ROM drive, tape drive, or a flash drive. Further, the operating system 2408 and the computer program 2410 are comprised of computer program instructions which, when accessed, read and executed by the computer 2402, causes the computer 2402 to perform the steps necessary to implement and/or use the present invention or to load the program of instructions into a memory, thus creating a special purpose data structure causing the computer to operate as a specially programmed computer executing the method steps described herein. Computer program 2410 and/or operating instructions may also be tangibly embodied in memory 2406 and/or data communications devices 2430, thereby making a computer program product or article of manufacture according to the invention. As such, the terms “article of manufacture,” “program storage device” and “computer program product” or “computer readable storage device” as used herein are intended to encompass a computer program accessible from any computer readable device or media.

Of course, those skilled in the art will recognize that any combination of the above components, or any number of different components, peripherals, and other devices, may be used with the computer 2402.

Furthermore, the operations performed in the foregoing disclosure can be performed by processor communicatively coupled to memory storing instructions for performing said operations. For example, the processor 1426 shown in FIG. 14 may perform instructions stored in memory 1432 to compute and/or compute and insert the watermark into media program frames as described above. Or in Whitebox implementations where a secure execution environment is not required, by processor 1434 executing instructions stored in memory 1436. Further, video and audio processors 1428 and 1430 may include processors that execute instructions stored in internal memory or the associated RAM 1414, 1418 to perform some or all of the described operations.

Although the term “computer” is referred to herein, it is understood that the computer may include set top boxes, or portable devices such as cellphones, portable MP3 players, video game consoles, notebook computers, pocket computers, or any other device with suitable processing, communication, and input/output capability.

### CONCLUSION

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of adding watermark data to a media program in a receiver disposed at a subscriber station, the receiver having a data processor communicatively coupled to a memory, the method comprising the steps of:
(a) receiving the media program in the receiver;
(b) generating, at least in part with a data processor executing processor instructions, a watermark, wherein the watermark is generated at least in part according to a data processor-unique identifier (PID);
(c) processing the received media program to reproduce the media program; and
(d) inserting portions of the generated watermark in the reproduced media program as determined at least in part according to the data processor-unique identifier to produce a watermarked media program provided for display, comprising:
(d)(1) inserting a first portion of the portions of the generated watermark in a first portion of a first frame of the reproduced media program;
(d)(2) inserting a further portion of the portions of the generated watermark in a further portion of a further frame of the media program, wherein at least one of the further frames of the media program and a segment of the further portion of the generated watermark within the further frame of the reproduced media program is selected at least in part according to the data processor-unique identifier;
(d)(3) repeating (d)(2) until all of the generated watermark is inserted in the media program; and
(d)(4) repeating (d)(1)-(d)(3) to insert the generated watermark in further frames of the media program.

2. The method of claim 1, wherein
the data processor is a secure data processor and the memory is a secure memory;
the method further comprises receiving the data processor-unique identifier (PID) in the receiver, comprising:
(a) receiving an encrypted customer global key E[CGK];
(b) receiving encrypted data ECGK[D], wherein the data (D) comprises the secure data processor-unique identifier (PID) and is encrypted according to the customer global key (CGK);
(c) decrypting the encrypted customer global key E[CGK] to reproduce the customer global key;
(d) decrypting the encrypted data ECGK[D] with the reproduced customer global key to reproduce the data (D); and
(e) securely storing the reproduced data (D) in the secure memory of the secure data processor.

3. The method of claim 2, wherein:
the encrypted global key E[CGK] is encrypted according to a secret value (SV) unique to the secure data processor ESV[CGK] and the secret value (SV) is securely and unalterably stored in the secure memory; and
decrypting the encrypted customer global key E[CGK] to reproduce the customer global key comprises:
decrypting the encrypted global key ESV[CGK] according to the secret value (SV) in the secure processor.

4. The method of claim 3, wherein:
the secret value (SV) is securely and unalterably stored in the secure memory via a black box device disposed at a manufacturer of the secure data processor and the secure memory.

5. The method of claim 2, wherein:
the encrypted customer global key E[CGK] is encrypted according to a product provisioning key (PPK) EPPK[CGK];
the method further comprises:
receiving an encrypted product provisioning key ESV[PPK], the product provisioning key (PPK) encrypted according to a secret value (SV) securely and unalterably stored in the secure memory; and
decrypting the encrypted product provisioning key ESV[PPK] according to the secret value (SV) in the secure processor to reproduce the product provisioning key (PPK); and
decrypting the encrypted customer global key E[CGK] to reproduce the customer global key (CGK) comprises:
decrypting the encrypted customer global key EPPK[CGK] according to the reproduced product provisioning key (PPK) to reproduce the customer global key (CGK).

6. The method of claim 1, wherein the further frame of the media program is selected at least in part according to the data processor-unique identifier.

7. The method of claim 6, wherein the first portion of the first frame is disposed in a same relative spatial location in the first frame as the further portion of the further frame.

8. The method of claim 1, wherein a spatial location of the further portion of the generated watermark within the further frame of the reproduced media program is selected at least in part according to the data processor-unique identifier.

9. The method of claim 1, wherein a size of the first portion of the generated watermark and a size of the further portion of the generated watermark differ.

10. The method of claim 1, wherein the first portion of the generated watermark and the further portion of the generated watermark are of a same size determined at least in part according to the data processor-unique identifier.

11. The method of claim 10, wherein the size is determined at least in part according to the data processor-unique identifier and a secret value.

12. The method of claim 1, wherein the generated watermark comprises a plurality of bits and the first portion of the generated watermark comprises a least significant bit of the plurality of bits.

13. The method of claim 1, wherein the first portion of the first frame of the reproduced media program comprises frame data, and the generated watermark replaces one or more least significant bits of the frame data.

14. The method of claim 1, where the portions of the generated watermark in the reproduced media program are inserted as determined at least in part according to an estimated perceptual characteristic of the reproduced media program.

15. The method of claim 1, wherein
the first frame of the media program and the further frame of the media program comprise frame data; and
the first portion and the first frame of the media program and the second portion of the second frame of the media program comprise frame data, and the frame data comprises at least one of:
color data;
luminance data;
hue data;
chrominance data;
intensity data;
fast Fourier coefficient data;
discrete cosine coefficient data;
wavelet series coefficient data;
Y, U or V data of YUV frame format; and
R, G or B data of RGB frame format.

16. The method of claim 1, wherein:
the first frame of the media program and the further frame of the media program comprise frame data; and
the first portion and the first frame of the media program and the second portion of the second frame of the media program comprise compressed frame data, and the frame data comprises at least one of:
macroblocks;
motion vectors in compression;
intra frame prediction values; and
timing information.

17. The method of claim 1, wherein:
(d)(1) inserting a first portion of the portions of the generated watermark in a first portion of a first frame of the reproduced media program comprises:
inserting a first character or first symbol mapped to a value of the first portion of the generated watermark; and
(d)(2) inserting a further portion of the portions of the generated watermark in a further portion of a further frame of the media program comprises:
inserting a further character or further symbol mapped to a value of the further portion of the generated watermark in the further portion of the further frame of the media program.

18. The method of claim 1, wherein:
the media program comprises a plurality of frames; and
each of the portions of the watermark are inserted into an associated one of the plurality of frames according to a deterministic interval.

19. The method of claim 1, further comprising the steps of:
searching for and reading the inserted first portion of the portions of the generated watermark in the first frame of the reproduced media program;
searching for and reading the inserted further portion of the portions of the generated watermark in the further frame of the reproduced media program; and
combining the read first portion and the read further portion to recover at least a portion of the inserted watermark.

20. The method of claim 1, wherein the at least one of the further frame of the media program and a location of the further portion of the generated watermark within the further frame of the reproduced media program is further selected at least in part according to a secret value.

21. The method of claim 20, wherein the secret value is generated by the client device and stored in the client device.

22. The method of claim 20, wherein:
the step of (b) generating the watermark comprises the steps of:
(b)(1) combining the data processor-unique identifier and the secret value to create a receiver-unique value;
(b)(2) generating a header comprising a start of frame marker; and
(b)(3) combining the header and the receiver-unique value to produce the generated watermark.

23. The method of claim 20, wherein:
the step (g)(1) of combining the data processor-unique identifier and the secret value to create a receiver-unique value comprises the step of encrypting the data processor-unique identifier according to the secret value to create a receiver-unique value; and
the step (g)(2) of combining the header and the receiver-unique value to produce the generated watermark comprises the step of concatenating the header and the receiver-unique value to produce the generated watermark.

24. The method of claim 20, further comprising:
(j) searching for and reading a start of frame marker in the media program to find the first portion of the generated watermark;
(k) searching for and reading the further frame of the media program for the further portion of the generated watermark;
(l) concatenating the first portion of the generated watermark and the further portion of the generated watermark;
(h) repeating steps (e)-(g) until the generated watermark is regenerated; and
(m) reproducing the data processor-unique identifier from the regenerated watermark.

25. The method of claim 1, further comprising:
receiving a downloaded Whitebox having the PID, and a crypto operation comprising a watermark operation; and
executing the downloaded Whitebox to select the at least one of the further frame of the media program and the further portion of the generated watermark within the further frame of the reproduced media program using the PID.

26. The method of claim 25 wherein the media program is provided by a content provider and the downloaded Whitebox unique from the content provider is different than a downloaded Whitebox from another content provider.

27. The method of claim 1, further comprising:
receiving a downloaded Whitebox having a secret value (SV), a decrypt element, and a crypto operation comprising a watermark operation;
receiving encrypted data ESV[D], the data (D) comprising the data processor-unique identifier (PID) and encrypted according to the secret value (SV); and
executing the downloaded Whitebox to decrypt the encrypted data ESV[D], to recover the PID and use the PID to select the at least one of the further frame of the media program and the location of the further portion of the generated watermark within the further frame of the reproduced media program.

28. A receiver, for adding watermark data to a media program received at a subscriber station, the receiver comprising a processor communicatively coupled to a memory, the memory storing processing instructions including processing instructions for:
(a) receiving the media program in the receiver;
(b) generating, at least in part with a data processor executing processor instructions, a watermark, wherein the watermark is generated at least in part according to a data processor-unique identifier (PID);
(c) processing the received media program to reproduce the media program; and
(d) inserting portions of the generated watermark in the reproduced media program as determined at least in part according to the data processor-unique identifier to produce a watermarked media program provided for display, comprising:
(d)(1) inserting a first portion of the portions of the generated watermark in a first portion of a first frame of the reproduced media program;
(d)(2) inserting a further portion of the portions of the generated watermark in a further portion of a further frame of the media program, wherein at least one of the further frame of the media program and a location of the further portion of the generated watermark within the further frame of the reproduced media program is selected at least in part according to the data processor-unique identifier;
(d)(3) repeating (d)(2) until all of the generated watermark is inserted in the media program; and
(d)(4) repeating (d)(1)-(d)(3) to insert the generated watermark in further frames of the media program.

29. The receiver of claim 28, wherein
the data processor is a secure data processor and the memory comprises a secure memory;
the instructions further comprise instructions for receiving the data processor-unique identifier (PID) in the receiver, comprising instructions for:
(a) receiving an encrypted customer global key E[CGK];
(b) receiving encrypted data ECGK[D], wherein the data (D) comprises the secure data processor-unique identifier (PID) and is encrypted according to the customer global key (CGK);
(c) decrypting the encrypted customer global key E[CGK] to reproduce the customer global key;
(d) decrypting the encrypted data ECGK[D] with the reproduced customer global key to reproduce the data (D); and
(e) securely storing the reproduced data (D) in the secure memory of the secure data processor.

30. The receiver of claim 29, wherein:
the encrypted global key E[CGK] is encrypted according to a secret value (SV) unique to the secure data processor ESV[CGK] and the secret value (SV) is securely and unalterably stored in the secure memory; and
the instructions for decrypting the encrypted customer global key E[CGK] to reproduce the customer global key comprise instructions for:
decrypting the encrypted global key ESV[CGK] according to the secret value (SV) in the secure processor.

31. The receiver of claim 30, wherein:
the secret value (SV) is securely and unalterably stored in the secure memory via a black box device disposed at a manufacturer of the secure data processor and the secure memory.

32. The receiver of claim 29, wherein:
the encrypted customer global key E[CGK] is encrypted according to a product provisioning key (PPK) EPPK[CGK]; and
the instructions further comprise instructions for:
receiving an encrypted product provisioning key ESV[PPK], the product provisioning key (PPK) encrypted according to a secret value (SV) securely and unalterably stored in the secure memory; and
decrypting the encrypted product provisioning key ESV[PPK] according to the secret value (SV) in the secure processor to reproduce the product provisioning key (PPK);
the instructions for decrypting the encrypted customer global key E[CGK] to reproduce the customer global key (CGK) comprise instructions for:
decrypting the encrypted customer global key EPPK[CGK] according to the reproduced product provisioning key (PPK) to reproduce the customer global key (CGK).

33. The receiver of claim 28, wherein the further frame of the media program is selected at least in part according to the data processor-unique identifier.

34. The receiver of claim 33, wherein the first portion of the first frame is disposed in a same relative spatial location in the first frame as the further portion of the further frame.

35. The receiver of claim 28, wherein a spatial location of the further portion of the generated watermark within the further frame of the reproduced media program is selected at least in part according to the data processor-unique identifier.

36. The receiver of claim 28, wherein a size of the first portion of the generated watermark and a size of the further portion of the generated watermark differ.

37. The receiver of claim 28, wherein the first portion of the generated watermark and the further portion of the generated watermark are of a same size determined at least in part according to the data processor-unique identifier.

38. The receiver of claim 37, wherein the size is determined at least in part according to the data processor-unique identifier and a secret value.

39. The receiver of claim 28, wherein the generated watermark comprises a plurality of bits and the first portion of the generated watermark comprises a least significant bit of the plurality of bits.

40. The receiver of claim 28, wherein the first portion of the first frame of the reproduced media program comprises frame data, and the generated watermark replaces one or more least significant bits of the frame data.

41. The receiver of claim 28, wherein:
the instructions for inserting a first portion of the portions of the generated watermark in a first portion of a first frame of the reproduced media program comprise instructions for:
inserting a first character or first symbol mapped to a value of the first portion of the generated watermark; and
the instructions for inserting a further portion of the portions of the generated watermark in a further portion of a further frame of the media program comprise instructions for:
inserting a further character or further symbol mapped to a value of the further portion of the generated watermark in the further portion of the further frame of the media program.

42. The receiver of claim 28, wherein the at least one of the further frame of the media program and a location of the further portion of the generated watermark within the further frame of the reproduced media program is further selected at least in part according to a secret value.

43. The receiver of claim 42, wherein:
the instructions for generating the watermark comprise instructions for:
combining the data processor-unique identifier and the secret value to create a receiver-unique value;
generating a header comprising a start of frame marker; and
combining the header and the receiver-unique value to produce the generated watermark.

44. The receiver of claim 42, wherein:
the instructions for combining the data processor-unique identifier and the secret value to create a receiver-unique value comprise instructions for encrypting the data processor-unique identifier according to the secret value to create a receiver-unique value; and
the instructions for combining the header and the receiver-unique value to produce the generated watermark comprise instructions for concatenating the header and the receiver-unique value to produce the generated watermark.

45. The receiver of claim 28, wherein:
the instructions for generating the watermark according to the data processor-unique identifier (PID) are performed by a crypto operation of a Whitebox having the PID.

46. The receiver of claim 28, wherein:
the instructions for inserting a further portion of the portions of the generated watermark in a further portion of the further frame of the media program, wherein at least one of the further frame of the media program and a location of the further portion of the generated watermark within the further frame of the reproduced media program is selected at least in part according to the data processor-unique identifier are performed at least in part by a crypto operation of a Whitebox having the PID.

47. The receiver of claim 28, wherein:
the receiver receives a downloaded Whitebox having a secret value (SV), a decrypt element, and a crypto operation comprising a watermark operation;
the receiver receives encrypted data ESV[D], the data (D) comprising the data processor-unique identifier (PID) and encrypted according to the secret value (SV); and
the receiver executes the downloaded Whitebox to decrypt the encrypted data ESV[D], to recover the PID and use the PID to select the at least one of the further frame of the media program and the location of the further portion of the generated watermark within the further frame of the reproduced media program.

48. An apparatus for adding watermark data to a media program in a receiver disposed at a subscriber station, the receiver having a data processor communicatively coupled to a memory, the apparatus comprising:
means for receiving the media program in the receiver;
means for generating, at least in part with a data processor executing processor instructions, a watermark, wherein the watermark is generated at least in part according to a data processor-unique identifier (PID);
means for processing the received media program to reproduce the media program; and
means for inserting portions of the generated watermark in the reproduced media program at locations determined at least in part according to the data processor-unique identifier to produce a watermarked media program provided for display, comprising:
means for inserting a first portion of the portions of the generated watermark in a first portion of a first frame of the reproduced media program; and
means for inserting a further portion of the portions of the generated watermark in a further portion of a further frame of the media program, wherein at least one of the further frame of the media program and a location of the further portion of the generated watermark within the further frame of the reproduced media program is selected at least in part according to the data processor-unique identifier.
